(19) United States
(12) Patent Application Publication
(10) Pub. No.: US 2025/0106865 A1
(43) Pub. Date: Mar. 27, 2025

(54) METHOD, DEVICE AND COMPUTER STORAGE MEDIUM FOR COMMUNICATION

(71) Applicant: NEC CORPORATION, Tokyo (JP)

(72) Inventors: Yukai GAO, Beijing (CN); Peng GUAN, Beijing (CN); Gang WANG, Beijing (CN)

(73) Assignee: NEC CORPORATION, Tokyo (JP)

(21) Appl. No.: 18/725,928

(22) PCT Filed: Dec. 30, 2021
(86) PCT No.: PCT/CN2021/143249

§ 371 Date: Jul. 1, 2024

(51) Int. Cl. H04W 72/231; H04L 1/1812; H04W 16/28; H04W 72/12; H04W 76/20

(52) U.S. Cl. CPC H04W 72/231; H04L 1/1812; H04W 16/28; H04W 72/12; H04W 76/20

(57) ABSTRACT

Embodiments of the present disclosure relate to methods, devices and computer storage media for communication. According to embodiments of the present disclosure, a terminal device transmits, to a network device, a first hybrid automatic repeat request acknowledgement (HARQ-ACK) information corresponding to a first downlink control information (DCI) in a first physical downlink control channel (PDCCH), wherein the first DCI indicates a first transmission configuration indicator (TCI) state. If a condition is fulfilled, the terminal device applies the first TCI state. In this way, the terminal device understands when and/or whether to apply the indicated TCI state.

### TECHNICAL FIELD

Embodiments of the present disclosure generally relate to the field of telecommunication, and in particular, to methods, devices and computer storage media for communication.

### BACKGROUND

In the 3GPP meeting RAN #86, it is agreed to support enhancement on multi-beam operation, mainly targeting the frequency range 2 (FR2) while also applicable to the frequency range 1 (FR1). It is agreed to identify and specify features to facilitate more efficient (lower latency and overhead) downlink (DL) and uplink (UL) beam management. For example, it is proposed to support common beam(s) for data and control information transmission/reception for both DL and UL, especially for intra-band carrier aggregation (CA). It is also proposed to support a unified Transmission Configuration Indication (TCI) framework for DL and UL beam indication. However, the current 3GPP specifications provide no details on when to apply the indicated TCI state.

### SUMMARY

In general, example embodiments of the present disclosure provide methods, devices and computer storage media for communications.

In a first aspect, there is provided a method of communication. The method comprises transmitting, at a terminal device and to a network device, a first hybrid automatic repeat request acknowledgement (HARQ-ACK) information corresponding to a first downlink control information (DCI) in a first physical downlink control channel (PDCCH), wherein the first DCI indicates a first transmission configuration indicator (TCI) state.

In a second aspect, there is provided a terminal device. The terminal device comprises a processor and a memory coupled to the processor. The memory stores instructions that when executed by the processor, cause the terminal device to perform actions. The actions comprise transmitting, at a terminal device and to a network device, a first hybrid automatic repeat request acknowledgement (HARQ-ACK) information corresponding to a first downlink control information (DCI) in a first physical downlink control channel (PDCCH), wherein the first DCI indicates a first transmission configuration indicator (TCI) state.

In a third aspect, there is provided a computer readable medium having instructions stored thereon. The instructions, when executed on at least one processor, cause the at least one processor to perform the method according to the above first aspect.

In a fourth aspect, there is provided a computer program product that is stored on a computer readable medium and includes machine-executable instructions. The machine-executable instructions, when being executed, cause a machine to perform the method according to the above first aspect.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Through the more detailed description of some embodiments of the present disclosure in the accompanying drawings, the above and other objects, features and advantages of the present disclosure will become more apparent, wherein:

FIG. 1 illustrates an example communication network in which embodiments of the present disclosure can be implemented;

FIG. 2 illustrates a signaling chart for signaling communication in accordance with some embodiments of the present disclosure;

FIG. 3 illustrates a schematic diagram of out-of-order hybrid automatic repeat request (HARQ) in accordance with some embodiments of the present disclosure;

FIG. 4 is a flowchart of an example method in accordance with an embodiment of the present disclosure;

FIG. 5 is a flowchart of an example method in accordance with an embodiment of the present disclosure; and

FIG. 6 is a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the singular forms ‘a’, ‘an’ and ‘the’ are intended to include the plural forms as well, unless the context clearly indicates otherwise. The term ‘includes’ and its variants are to be read as open terms that mean ‘includes, but is not limited to.’ The term ‘based on’ is to be read as ‘at least in part based on.’ The term ‘some embodiments’ and ‘an embodiment’ are to be read as ‘at least some embodiments.’ The term ‘another embodiment’ is to be read as ‘at least one other embodiment.’ The terms ‘first,’ ‘second,’ and the like may refer to different or same objects. Other definitions, explicit and implicit, may be included below.

In some examples, values, procedures, or apparatus are referred to as ‘best,’ ‘lowest,’ ‘highest,’ ‘minimum,’ ‘maximum,’ or the like. It will be appreciated that such descriptions are intended to indicate that a selection among many used functional alternatives can be made, and such selections need not be better, smaller, higher, or otherwise preferable to other selections.

In the 3GPP meeting RAN #86, it is agreed to support enhancement on multi-beam operation, mainly targeting FR2 while also applicable to FR1. It is agreed to identify and specify features to facilitate more efficient (lower latency and overhead) DL and UL beam management. For example, it is proposed to support common beam(s) for data and control information transmission/reception for both DL and UL, especially for intra-band CA. It is also proposed to support a unified TCI framework for DL and UL beam indication. However, the current 3GPP specifications provide no details on when to apply the indicated TCI state. For example, it is not clear how to deal with out of order HARQ. Moreover, it is also not clear whether to apply an indicated TCI state.

In order to at least solve the above and/or potential issues, solutions on beam management are proposed. According to embodiments of the present disclosure, a terminal device transmits, to a network device, a first hybrid automatic repeat request acknowledgement (HARQ-ACK) information corresponding to a first downlink control information (DCI) in a first physical downlink control channel (PDCCH), wherein the first DCI indicates a first transmission configuration indicator (TCI) state. If a condition is fulfilled, the terminal device applies the first TCI state. In this way, the terminal device understands when and/or whether to apply the indicated TCI state.

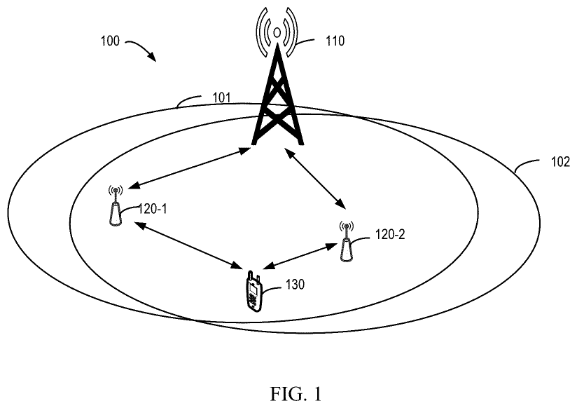

FIG. 1 illustrates an example communication network 100 in which embodiments of the present disclosure can be implemented. As shown in FIG. 1, the network 100 includes a network device 110. For example, the network device 110 may be configured with two TRPs/panels 120-1 and 120-2 (collectively referred to as TRPs 120 or individually referred to as TRP 120). The network 100 also includes a terminal device 130 served by the network device 110. It is to be understood that the number of network devices, terminal devices and TRPs as shown in FIG. 1 is only for the purpose of illustration without suggesting any limitations to the present disclosure. The network 100 may include any suitable number of devices adapted for implementing embodiments of the present disclosure.

As used herein, the term “terminal device” refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IoT) devices, Internet of Everything (IoE) devices, machine type communication (MTC) devices, Ultra-Reliable Low latency Communication (URLLC) devices, device on vehicle for V2X communication where X means pedestrian, vehicle, or infrastructure/network, or image capture devices such as digital cameras, gaming devices, music storage and playback appliances, or Internet appliances enabling wireless or wired Internet access and browsing and the like. For the purpose of discussion, in the following, some embodiments will be described with reference to UE as an example of the terminal device 130.

As used herein, the term ‘network device’ or ‘base station’ (BS) refers to a device which is capable of providing or hosting a cell or coverage where terminal devices can communicate. Examples of a network device include, but not limited to, a Node B (NodeB or NB), an Evolved NodeB (eNodeB or eNB), a next generation NodeB (gNB), a Transmission Reception Point (TRP), a Remote Radio Unit (RRU), a radio head (RH), a remote radio head (RRH), a low power node such as a femto node, a pico node, and the like. The term “TRP” refers to an antenna array (with one or more antenna elements) available to the network device located at a specific geographical location. For example, a network device may be coupled with multiple TRPs in different geographical locations to achieve better coverage. It is to be understood that the TRP can also be referred to as a “panel”, which also refers to an antenna array (with one or more antenna elements) or a group of antennas.

In one embodiment, the terminal device 130 may be connected with a first network device and a second network device (not shown in FIG. 1). One of the first network device and the second network device may be in a master node and the other one may be in a secondary node. The first network device and the second network device may use different radio access technologies (RATs). In one embodiment, the first network device may be a first RAT device and the second network device may be a second RAT device. In one embodiment, the first RAT device may be an eNB and the second RAT device is a gNB. Information related to different RATs may be transmitted to the terminal device 130 from at least one of the first network device and the second network device. In one embodiment, first information may be transmitted to the terminal device 130 from the first network device and second information may be transmitted to the terminal device 130 from the second network device directly or via the first network device. In one embodiment, information related to configuration for the terminal device configured by the second network device may be transmitted from the second network device via the first network device. Information related to reconfiguration for the terminal device configured by the second network device may be transmitted to the terminal device from the second network device directly or via the first network device. The information may be transmitted via any of the following: Radio Resource Control (RRC) signaling, Medium Access Control (MAC) control element (CE) or Downlink Control Information (DCI).

In the communication network 100, the network device 110 can communicate data and control information to the terminal device 130 and the terminal device 130 can also communication data and control information to the network device 110. A link from the network device 110 to the terminal device 130 is referred to as a downlink (DL), while a link from the terminal device 130 to the network device 110 is referred to as an uplink (UL).

The communications in the network 100 may conform to any suitable standards including, but not limited to, Global System for Mobile Communications (GSM), Long Term Evolution (LTE), LTE-Evolution, LTE-Advanced (LTE-A), Wideband Code Division Multiple Access (WCDMA), Code Division Multiple Access (CDMA), GSM EDGE Radio Access Network (GERAN), Machine Type Communication (MTC) and the like. Furthermore, the communications may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols.

As shown in FIG. 1, the network device 110 may communicate with the terminal device 130 via the TRPs 120-1 and 120-2. In the following text, the TRP 120-1 may be also referred to as the first TRP, while the TRP 120-2 may be also referred to as the second TRP. Each of the TRPs 120 may provide a plurality of beams for communication with the terminal device 130.

In some embodiments, the first and second TRPs 120 may be explicitly associated with different higher-layer configured identities. For example, a higher-layer configured identity can be associated with a Control Resource Set (CORESET), a reference signal (RS), or a Transmission Configuration Indication (TCI) state, which is used to differentiate between transmissions between different TRPs 120 and the terminal device 130. When the terminal device 130 receives two DCIs in two CORESETs which are associated with different higher-layer configured identities, the two DCIs are indicated from different TRPs. Further, the first and second TRPs 120 may be implicitly identified by a dedicated configuration to the physical channels or signals. For example, a dedicated CORESET, a RS, and a TCI state, which are associated with a TRP, are used to identify a transmission from a different TRP to the terminal device 130. For example, when the terminal device 130 receives a DCI from a dedicated CORESET, the DCI is indicated from the associated TRP dedicated by the CORESET.

In the repeated transmission or reception via the two TRPs 120, the network device 110 may select a repetition scheme from among a number of available repetition schemes. The repetition scheme may specify a transmission manner for the network device 110 to use the two TRPs 120 cooperatively, for example, a multiplexing scheme between the two TRPs 120, the respective resource allocations for the two TRPs 120, or the like.

For example, schemes for multi-TRP/multi-panel based URLLC, scheduled by single downlink control information (DCI) at least, may be as following.

Scheme 1 (SDM): n (n<=Nₛ) TCI states within the single slot, with overlapped time and frequency resource allocation.

Scheme 1a: Each transmission occasion is a layer or a set of layers of the same TB, with each layer or layer set is associated with one TCI and one set of DMRS port(s). Single codeword with one RV is used across all spatial layers or layer sets. From the UE perspective, different coded bits are mapped to different layers or layer sets with the same mapping rule as in Rel-15.

Scheme 1b: Each transmission occasion is a layer or a set of layers of the same TB, with each layer or layer set is associated with one TCI and one set of DMRS port(s). Single codeword with one RV is used for each spatial layer or layer set. The RVs corresponding to each spatial layer or layer set can be the same or different. Codeword-to-layer mapping when total number of layers <=4 is for future study.

Scheme 1c: One transmission occasion is one layer of the same TB with one DMRS port associated with multiple TCI state indices, or one layer of the same TB with multiple DMRS ports associated with multiple TCI state indices one by one.

In addition, it is indicated that applying different MCS/modulation orders for different layers or layer sets can be discussed.

Scheme 2 (FDM): n (n<=N_{f}) TCI states are within the single slot, with non-overlapped frequency resource allocation. Each non-overlapped frequency resource allocation is associated with one TCI state. Same single/multiple DMRS port(s) are associated with all non-overlapped frequency resource allocations.

Scheme 2a: Single codeword with one RV is used across full resource allocation. From UE perspective, the common RB mapping (codeword to layer mapping as in Rel-15) is applied across full resource allocation. In some embodiments, a terminal device may be configured or set with FDMschemeA by a high layer parameter. For example, the high layer parameter may be an RRC parameter. For example, the high layer parameter may be URLLCSchemeEnabler.

Scheme 2b: Single codeword with one RV is used for each non-overlapped frequency resource allocation. The RVs corresponding to each non-overlapped frequency resource allocation can be the same or different. In some embodiments, a terminal device may be configured or set with FDMschemeB by a high layer parameter. For example, the high layer parameter may be an RRC parameter. For example, the high layer parameter may be URLLCSchemeEnabler.

In addition, it is indicated that applying different MCS/modulation orders for different non-overlapped frequency resource allocations can be discussed. It is also indicated that details of frequency resource allocation mechanism for FDM 2a/2b with regarding to allocation granularity, time domain allocation can be discussed.

Scheme 3 (TDM or intra-slot repetition): n (n<=Nₜ₁) TCI states within the single slot, with non-overlapped time resource allocation. Each transmission occasion of the TB has one TCI and one RV with the time granularity of mini-slot. All transmission occasion (s) within the slot use a common MCS with same single or multiple DMRS port(s). RV/TCI state can be same or different among transmission occasions. Channel estimation interpolation across mini-slots with the same TCI index is for future study. In some embodiments, a terminal device may be configured or set with TDMschemeA by a high layer parameter. For example, the high layer parameter may be an RRC parameter. For example, the high layer parameter may be URLLCSchemeEnabler.

Scheme 4 (TDM or inter-slot repetition): n (n<=Nₜ₂) TCI states with K (n<=K) different slots. Each transmission occasion of the TB has one TCI and one RV. All transmission occasion (s) across K slots use a common MCS with same single or multiple DMRS port(s). RV/TCI state can be same or different among transmission occasions. Channel estimation interpolation across slots with the same TCI index is for future study.

In some embodiments, before transmitting data (such as, via the TRP 120-1 and/or 120-2) to the terminal device 130, the network device 110 may transmit control information associated with the transmission of the data. For example, the control information can schedule a set of resources for the transmission of the data and indicate various transmission parameters related to the transmission of the data, such as, one or more TCI states, a Frequency Domain Resource Assignment (FDRA), a Time Domain Resource Assignment (TDRA) which may include a slot offset and a start/length indicator value, a Demodulation Reference Signal (DMRS) group, a Redundancy Version (RV), as defined in the 3GPP specifications. It is to be understood that the transmission parameters indicated in the control information 135 are not limited to the ones as listed above. Embodiments of the present disclosure may equally applicable to control information including any transmission parameters.

In the following, the terms “transmission occasions”, “reception occasions”, “repetitions”, “transmission”, “reception”, “PDSCH transmission occasions”, “PDSCH repetitions”, “PUSCH transmission occasions”, “PUSCH repetitions”, “PUCCH occasions”, “PUCCH repetitions”, “repeated transmissions”, “repeated receptions”, “PDSCH transmissions”, “PDSCH receptions”, “PUSCH transmissions”, “PUSCH receptions”, “PUCCH transmissions”, “PUCCH receptions”, “RS transmission”, “RS reception”, “communication”, “transmissions” and “receptions” can be used interchangeably. The terms “TCI state”, “set of QCL parameter(s)”, “QCL parameter(s)”, “QCL assumption” and “QCL configuration” can be used interchangeably. The terms “TCI field”, “TCI state field”, and “transmission configuration indication” can be used interchangeably. The terms “transmission occasion”, “transmission”, “repetition”, “reception”, “reception occasion”, “monitoring occasion”, “PDCCH monitoring occasion”, “PDCCH transmission occasion”, “PDCCH transmission”, “PDCCH candidate”, “PDCCH reception occasion”, “PDCCH reception”, “search space”, “CORESET”, “multi-chance” and “PDCCH repetition” can be used interchangeably. In the following, the terms “PDCCH repetitions”, “repeated PDCCHs”, “repeated PDCCH signals”, “PDCCH candidates configured for same scheduling”, “PDCCH”, “PDCCH candidates” and “linked PDCCH candidates” can be used interchangeably. The terms “DCI” and “DCI format” can be used interchangeably. In some embodiments, the embodiments in this disclosure can be applied to PDSCH and PUSCH scheduling, and in the following, PDSCH scheduling is described as examples. For example, the embodiments in this disclosure can be applied to PUSCH by replacing “transmit” to “receive” and/or “receive” to “transmit”. The terms “PDSCH” and “PUSCH” can be used interchangeably. The terms “transmit” and “receive” can be used interchangeably. The terms “common beam”, “common beam update/indicate/indication”, “unified TCI state”, “unified TCI state update/indicate/indication”, “beam indication”, “TCI state(s) indication”, “TCI_state_r17”, “tci_StateId_r17”, “TCI_state_r17 indicating a unified TCI state”, “TCI state shared/applied for all or subset of CORESETs and UE-dedicated reception on PDSCH”, “Rel-17 TCI state”, “TCI state with tci_StateId_r17”, “TCI state configured for TCI state update in unified TCI framework”, “TCI state indicated in DCI for common beam update/indicate/indication” and “TCI state indicated in DCI and to be applied for all/subset of CORESETs and PDSCH” may be used interchangeably. The terms “subset of CORESETs”, “subset of TCI states”, “subset of unified TCI states”, “subset of downlink (unified) TCI states” and “subset of joint (unified) TCI states” may be used interchangeably. The terms “subset of PUCCHs”, “subset of TCI states”, “subset of unified TCI states”, “subset of uplink (unified) TCI states” and “subset of joint (unified) TCI states” may be used interchangeably.

As specified in the 3GPP specifications (TS 38.214), a UE can be configured with a list of up to T TCI-State configurations within the higher layer parameter PDSCH-Config to decode PDSCH according to a detected PDCCH with DCI intended for the UE and the given serving cell, where T depends on the UE capability maxNumberConfiguredTCIstatesPerCC. Each TCI-State contains parameters for configuring a quasi co-location relationship between one or two downlink reference signals and the DMRS ports of the PDSCH, the DMRS port of PDCCH or the channel state information reference signal (CSI-RS) port(s) of a CSI-RS resource. The quasi co-location relationship is configured by the higher layer parameter qcl-Type1 for the first downlink (DL) RS, and qcl-Type2 for the second DL RS (if configured). For the case of two DL RSs, the QCL types shall not be the same, regardless of whether the references are to the same DL RS or different DL RSs. The quasi co-location types corresponding to each DL RS are given by the higher layer parameter qcl-Type in QCL-Info and may take one of the following values:
‘QCL-TypeA’: {Doppler shift, Doppler spread, average delay, delay spread}
‘QCL-TypeB’: {Doppler shift, Doppler spread}
‘QCL-TypeC’: {Doppler shift, average delay}
‘QCL-TypeD’: {Spatial Rx parameter}

The UE receives an activation command, as described in clause “TCI States Activation/Deactivation for UE-specific PDSCH MAC CE” (for example, clause 6.1.3.14) of [TS 38.321] or in clause “Enhanced TCI States Activation/Deactivation for UE-specific PDSCH MAC CE” (for example, clause 6.1.3) of [TS 38.321], used to map up to 8 TCI states to the codepoints of the DCI field ‘Transmission Configuration Indication’ in one CC/DL BWP or in a set of CCs/DL BWPs, respectively. When a set of TCI state IDs are activated for a set of CCs/DL BWPs, where the applicable list of CCs is determined by indicated CC in the activation command, the same set of TCI state IDs are applied for all DL BWPs in the indicated CCs.

When a UE supports two TCI states in a codepoint of the DCI field ‘Transmission Configuration Indication’ the UE may receive an activation command, as described in clause “TCI States Activation/Deactivation for UE-specific PDSCH MAC CE” or clause “Enhanced TCI States Activation/Deactivation for UE-specific PDSCH MAC CE” (for example, clause 6.1.3.14 or subclause under 6.1.3) of [TS 38.321], the activation command is used to map up to 8 combinations of one or two TCI states to the codepoints of the DCI field ‘Transmission Configuration Indication’. The UE is not expected to receive more than 8 TCI states in the activation command.

When the DCI field ‘Transmission Configuration Indication’ is present in DCI format 1_2 and when the number of codepoints S in the DCI field ‘Transmission Configuration Indication’ of DCI format 1_2 is smaller than the number of TCI codepoints that are activated by the activation command, as described in clause 6.1.3.14 and 6.1.3.24 of [10, TS38.321], only the first S activated codepoints are applied for DCI format 1_2.

When the UE would transmit a PUCCH with HARQ-ACK information in slot n corresponding to the PDSCH carrying the activation command, the indicated mapping between TCI states and codepoints of the DCI field ‘Transmission Configuration Indication’ should be applied starting from the first slot that is after slot n+3Nₛₗₒₜ^{subframe,μ} where [symbol] is the SCS configuration for the PUCCH. If tci-PresentInDCI is set to ‘enabled’ or tci-PresentDCI-1-2 is configured for the CORESET scheduling the PDSCH, and the time offset between the reception of the DL DCI and the corresponding PDSCH is equal to or greater than timeDurationForQCL if applicable, after a UE receives an initial higher layer configuration of TCI states and before reception of the activation command, the UE may assume that the DM-RS ports of PDSCH of a serving cell are quasi co-located with the SS/PBCH block determined in the initial access procedure with respect to qcl-Type set to ‘typeA’, and when applicable, also with respect to qcl-Type set to ‘typeD’.

In some embodiments, if a UE is configured with the higher layer parameter tci-PresentInDCI that is set as ‘enabled’ or tci-PresentInDCI-ForFormat1_2 is configured for the CORESET scheduling the PDSCH, the UE assumes that the TCI field is present in the DCI (for example DCI format 1_1 or DCI format 1_2) of the PDCCH transmitted on the CORESET. If tci-PresentInDCI or tci-PresentInDCI-ForFormat1_2 is not configured for the CORESET scheduling the PDSCH or the PDSCH is scheduled by a DCI (for example, DCI format 1_0), the UE assumes that the TCI field is not present in the DCI (for example DCI format 1_1 or DCI format 1_2 or DCI format 1_0) of the PDCCH transmitted on the CORESET. If the PDSCH is scheduled by a DCI format not having the TCI field present, and the time offset between the reception of the DL DCI and the corresponding PDSCH of a serving cell is equal to or greater than a threshold timeDurationForQCL if applicable, where the threshold is based on reported UE capability [13, TS 38.306], for determining PDSCH antenna port quasi co-location, the UE assumes that the TCI state or the QCL assumption for the PDSCH is identical to the TCI state or QCL assumption whichever is applied for the CORESET used for the PDCCH transmission within the active BWP of the serving cell.

If tci-PresentInDCI is set to “enabled” or tci-PresentInDCI-ForFormat1_2 is configured for the CORESET scheduling the PDSCH, and the time offset between the reception of the DL DCI and the corresponding PDSCH is equal to or greater than timeDurationForQCL if applicable, after a UE receives an initial higher layer configuration of TCI states and before reception of the activation command, the UE may assume that the DMRS ports of PDSCH of a serving cell are quasi co-located with the SS/PBCH block determined in the initial access procedure with respect to ‘QCL-TypeA’, and when applicable, also with respect to ‘QCL-TypeD’. The value of timeDurationForQCL is based on reported UE capability.

If a UE is configured with the higher layer parameter tci-PresentInDCI that is set as ‘enabled’ for the CORESET scheduling the PDSCH, the UE assumes that the TCI field is present in the DCI (for example, DCI format 1_1) of the PDCCH transmitted on the CORESET. If a UE is configured with the higher layer parameter tci-PresentInDCI-ForFormat1_2 for the CORESET scheduling the PDSCH, the UE assumes that the TCI field with a DCI field size indicated by tci-PresentInDCI-ForFormat1_2 is present in the DCI (for example, DCI format 1_2) of the PDCCH transmitted on the CORESET. If the PDSCH is scheduled by a DCI format not having the TCI field present, and the time offset between the reception of the DL DCI and the corresponding PDSCH is equal to or greater than a threshold timeDurationForQCL if applicable, where the threshold is based on reported UE capability [TS 38.306], for determining PDSCH antenna port quasi co-location, the UE assumes that the TCI state or the QCL assumption for the PDSCH is identical to the TCI state or QCL assumption whichever is applied for the CORESET used for the PDCCH transmission within the active BWP of the serving cell.

If the PDSCH is scheduled by a DCI format having the TCI field present, the TCI field in DCI in the scheduling component carrier points to the activated TCI states in the scheduled component carrier or DL BWP, the UE shall use the TCI-State according to the value of the ‘Transmission Configuration Indication’ field in the detected PDCCH with DCI for determining PDSCH antenna port quasi co-location. The UE may assume that the DM-RS ports of PDSCH of a serving cell are quasi co-located with the RS(s) in the TCI state with respect to the QCL type parameter(s) given by the indicated TCI state if the time offset between the reception of the DL DCI and the corresponding PDSCH is equal to or greater than a threshold timeDurationForQCL, where the threshold is based on reported UE capability [TS 38.306]. When the UE is configured with a single slot PDSCH, the indicated TCI state should be based on the activated TCI states in the slot with the scheduled PDSCH. When the UE is configured with a multi-slot PDSCH, the indicated TCI state should be based on the activated TCI states in the first slot with the scheduled PDSCH, and UE shall expect the activated TCI states are the same across the slots with the scheduled PDSCH. When the UE is configured with CORESET associated with a search space set for cross-carrier scheduling, and the PDCCH carrying the scheduling DCI and the PDSCH scheduled by that DCI are transmitted on the same carrier, the UE expects tci-PresentInDCI is set as ‘enabled’ or tci-PresentInDCI-ForFormat1_2 is configured for the CORESET, and if one or more of the TCI states configured for the serving cell scheduled by the search space set contains ‘QCL-TypeD’, the UE expects the time offset between the reception of the detected PDCCH in the search space set and the corresponding PDSCH is larger than or equal to the threshold timeDurationForQCL.

Independent of the configuration of tci-PresentInDCI and tci-PresentInDCI-ForFormat1_2 in RRC connected mode, if the offset between the reception of the DL DCI and the corresponding PDSCH is less than the threshold timeDurationForQCL and at least one configured TCI state for the serving cell of scheduled PDSCH contains qcl-Type set to ‘typeD’.

The UE may assume that the DM-RS ports of PDSCH of a serving cell are quasi co-located with the RS(s) with respect to the QCL parameter(s) used for PDCCH quasi co-location indication of the CORESET associated with a monitored search space with the lowest controlResourceSetId in the latest slot in which one or more CORESETs within the active BWP of the serving cell are monitored by the UE. In this case, if the qcl-Type is set to ‘typeD’ of the PDSCH DM-RS is different from that of the PDCCH DM-RS with which they overlap in at least one symbol, the UE is expected to prioritize the reception of PDCCH associated with that CORESET. This also applies to the intra-band CA case (when PDSCH and the CORESET are in different component carriers).

If a UE is configured with enableDefaultTCIStatePerCoresetPoolIndex and the UE is configured by higher layer parameter PDCCH-Config that contains two different values of coresetPoolIndex in different ControlResourceSets.

The UE may assume that the DM-RS ports of PDSCH associated with a value of coresetPoolIndex of a serving cell are quasi co-located with the RS(s) with respect to the QCL parameter(s) used for PDCCH quasi co-location indication of the CORESET associated with a monitored search space with the lowest controlResourceSetId among CORESETs, which are configured with the same value of coresetPoolIndex as the PDCCH scheduling that PDSCH, in the latest slot in which one or more CORESETs associated with the same value of coresetPoolIndex as the PDCCH scheduling that PDSCH within the active BWP of the serving cell are monitored by the UE. In this case, if the ‘QCL-TypeD’ of the PDSCH DM-RS is different from that of the PDCCH DM-RS with which they overlap in at least one symbol and they are associated with same coresetPoolIndex, the UE is expected to prioritize the reception of PDCCH associated with that CORESET. This also applies to the intra-band CA case (when PDSCH and the CORESET are in different component carriers).

If a UE is configured with enableTwoDefaultTCI-States, and at least one TCI codepoint indicates two TCI states, the UE may assume that the DM-RS ports of PDSCH or PDSCH transmission occasions of a serving cell are quasi co-located with the RS(s) with respect to the QCL parameter(s) associated with the TCI states corresponding to the lowest codepoint among the TCI codepoints containing two different TCI states. When the UE is configured by higher layer parameter repetitionScheme set to ‘tdmSchemeA’ or is configured with higher layer parameter repetitionNumber, the mapping of the TCI states to PDSCH transmission occasions is determined according to clause 5.1.2.1 by replacing the indicated TCI states with the TCI states corresponding to the lowest codepoint among the TCI codepoints containing two different TCI states based on the activated TCI states in the slot with the first PDSCH transmission occasion. In this case, if the ‘QCL-TypeD’ in both of the TCI states corresponding to the lowest codepoint among the TCI codepoints containing two different TCI states is different from that of the PDCCH DM-RS with which they overlap in at least one symbol, the UE is expected to prioritize the reception of PDCCH associated with that CORESET. This also applies to the intra-band CA case (when PDSCH and the CORESET are in different component carriers).

In all cases above, if none of configured TCI states for the serving cell of scheduled PDSCH is configured with qcl-Type set to ‘typeD’, the UE shall obtain the other QCL assumptions from the indicated TCI states for its scheduled PDSCH irrespective of the time offset between the reception of the DL DCI and the corresponding PDSCH.

If the PDCCH carrying the scheduling DCI is received on one component carrier, and the PDSCH scheduled by that DCI is on another component carrier and the UE is configured with enableDefaultBeam-ForCCS:
The timeDurationForQCL is determined based on the subcarrier spacing of the scheduled PDSCH. If μ_{PDCCH}<μ_{PDSCH} an additional timing delay

$$d \frac{{2}^{{μ}_{PDSCH}}}{{2}^{{μ}_{PDCCH}}}$$

is added to the timeDurationForQCL, where d is defined in 5.2.1.5.1a-1, otherwise d is zero;
For both the cases, when the offset between the reception of the DL DCI and the corresponding PDSCH is less than the threshold timeDurationForQCL, and when the DL DCI does not have the TCI field present, the UE obtains its QCL assumption for the scheduled PDSCH from the activated TCI state with the lowest ID applicable to PDSCH in the active BWP of the scheduled cell.

For a periodic CSI-RS resource in an NZP-CSI-RS-ResourceSet configured with higher layer parameter trs-Info, the UE shall expect that a TCI-State indicates one of the following quasi co-location type(s):
‘typeC’ with an SS/PBCH block and, when applicable, ‘typeD’ with the same SS/PBCH block, or
‘typeC’ with an SS/PBCH block and, when applicable, ‘typeD’ with a CSI-RS resource in an NZP-CSI-RS-ResourceSet configured with higher layer parameter repetition, or.

For an aperiodic CSI-RS resource in an NZP-CSI-RS-ResourceSet configured with higher layer parameter trs-Info, the UE shall expect that a TCI-State indicates qcl-Type set to ‘typeA’ with a periodic CSI-RS resource in a NZP-CSI-RS-ResourceSet configured with higher layer parameter trs-Info and, when applicable, qcl-Type set to ‘typeD’ with the same periodic CSI-RS resource.

For a CSI-RS resource in an NZP-CSI-RS-ResourceSet configured without higher layer parameter trs-Info and without the higher layer parameter repetition, the UE shall expect that a TCI-State indicates one of the following quasi co-location type(s):
‘typeA’ with a CSI-RS resource in a NZP-CSI-RS-ResourceSet configured with higher layer parameter trs-Info and, when applicable, ‘typeD’ with the same CSI-RS resource, or
‘typeA’ with a CSI-RS resource in a NZP-CSI-RS-ResourceSet configured with higher layer parameter trs-Info and, when applicable, ‘typeD’ with an SS/PBCH block, or
‘typeA’ with a CSI-RS resource in a NZP-CSI-RS-ResourceSet configured with higher layer parameter trs-Info and, when applicable, ‘typeD’ with a CSI-RS resource in a NZP-CSI-RS-ResourceSet configured with higher layer parameter repetition, or
‘typeB’ with a CSI-RS resource in a NZP-CSI-RS-ResourceSet configured with higher layer parameter trs-Info when ‘typeD’ is not applicable.

For a CSI-RS resource in an NZP-CSI-RS-ResourceSet configured with higher layer parameter repetition, the UE shall expect that a TCI-State indicates one of the following quasi co-location type(s):
‘typeA’ with a CSI-RS resource in a NZP-CSI-RS-ResourceSet configured with higher layer parameter trs-Info and, when applicable, ‘typeD’ with the same CSI-RS resource, or
‘typeA’ with a CSI-RS resource in a NZP-CSI-RS-ResourceSet configured with higher layer parameter trs-Info and, when applicable, ‘typeD’ with a CSI-RS resource in a NZP-CSI-RS-ResourceSet configured with higher layer parameter repetition, or
‘typeC’ with an SS/PBCH block and, when applicable, ‘typeD’ with the same SS/PBCH block.

For the DM-RS of PDCCH, the UE shall expect that a TCI-State indicates one of the following quasi co-location type(s):
‘typeA’ with a CSI-RS resource in a NZP-CSI-RS-ResourceSet configured with higher layer parameter trs-Info and, when applicable, ‘typeD’ with the same CSI-RS resource, or
‘typeA’ with a CSI-RS resource in a NZP-CSI-RS-ResourceSet configured with higher layer parameter trs-Info and, when applicable, ‘typeD’ with a CSI-RS resource in an NZP-CSI-RS-ResourceSet configured with higher layer parameter repetition, or
‘typeA’ with a CSI-RS resource in a NZP-CSI-RS-ResourceSet configured without higher layer parameter trs-Info and without higher layer parameter repetition and, when applicable, ‘typeD’ with the same CSI-RS resource.

For the DM-RS of PDSCH, the UE shall expect that a TCI-State indicates one of the following quasi co-location type(s):
‘typeA’ with a CSI-RS resource in a NZP-CSI-RS-ResourceSet configured with higher layer parameter trs-Info and, when applicable, ‘typeD’ with the same CSI-RS resource, or
‘typeA’ with a CSI-RS resource in a NZP-CSI-RS-ResourceSet configured with higher layer parameter trs-Info and, when applicable, ‘typeD’ with a CSI-RS resource in an NZP-CSI-RS-ResourceSet configured with higher layer parameter repetition,or
typeA’ with a CSI-RS resource in a NZP-CSI-RS-ResourceSet configured without higher layer parameter trs-Info and without higher layer parameter repetition and, when applicable, ‘typeD’ with the same CSI-RS resource.

If the PDCCH carrying the scheduling DCI is received on one component carrier, and the PDSCH scheduled by that DCI is on another component carrier: The timeDurationForQCL is determined based on the subcarrier spacing of the scheduled PDSCH. If μ_{PDCCH}<μ_{PDSCH} an additional timing delay d is added to the timeDurationForQCL, where d is defined as 8 symbols if subcarrier spacing for the PDCCH is 15 kHz, or 8 symbols if subcarrier spacing for the PDCCH is 30 kHz, or 14 symbols if subcarrier spacing for the PDCCH is 60 kHz. For example, the symbol is PDCCH symbol, or the symbol is based on the subcarrier spacing of PDCCH (for example, as defined in Table 5.2.1.5.1a-1 of TS 38.214); For both the cases when tci-PresentInDCI is set to ‘enabled’ and the offset between the reception of the DL DCI and the corresponding PDSCH is less than the threshold timeDurationForQCL and when tci-PresentInDCI is not configured, the UE obtains its QCL assumption for the scheduled PDSCH from the activated TCI state with the lowest ID applicable to PDSCH in the active BWP of the scheduled cell.

As specified in the 3GPP specifications (TS 38.214), when a UE is configured by higher layer parameter RepSchemeEnabler set to one of ‘FDMSchemeA’, ‘FDMSchemeB’, ‘TDMSchemeA’, if the UE is indicated with two TCI states in a codepoint of the DCI field ‘Transmission Configuration Indication’ and DMRS port(s) within one CDM (Code Domain Multiplexing) group in the DCI field “Antenna Port(s)”. When two TCI states are indicated in a DCI and the UE is set to ‘FDMSchemeA’, the UE shall receive a single PDSCH transmission occasion of the TB with each TCI state associated to a non-overlapping frequency domain resource allocation as described in clause “Physical resource block (PRB) bundling” (for example Clause 5.1.2.3) in TS 38.214. When two TCI states are indicated in a DCI and the UE is set to ‘FDMSchemeB’, the UE shall receive two PDSCH transmission occasions of the same TB with each TCI state associated to a PDSCH transmission occasion which has non-overlapping frequency domain resource allocation with respect to the other PDSCH transmission occasion as described in clause “Physical resource block (PRB) bundling” (for example Clause 5.1.2.3) in TS 38.214. When two TCI states are indicated in a DCI and the UE is set to ‘TDMSchemeA’, the UE shall receive two PDSCH transmission occasions of the same TB with each TCI state associated to a PDSCH transmission occasion which has non-overlapping time domain resource allocation with respect to the other PDSCH transmission occasion and both PDSCH transmission occasions shall be received within a given slot as described in Clause “Resource allocation in time domain” (for example, clause 5.1.2.1) in TS 38.214.

When a UE is configured by the higher layer parameter PDSCH-config that indicates at least one entry in pdsch-TimeDomainAllocationList containing RepNumR16 in PDSCH-TimeDomainResourceAllocation, the UE may expect to be indicated with one or two TCI states in a codepoint of the DCI field ‘Transmission Configuration Indication’ together with the DCI field “Time domain resource assignment’ indicating an entry in pdsch-TimeDomainAllocationList which contain RepNum16 in PDSCH-TimeDomainResourceAllocation and DM-RS port(s) within one CDM group in the DCI field “Antenna Port(s)”. When two TCI states are indicated in a DCI with ‘Transmission Configuration Indication’ field, the UE may expect to receive multiple slot level PDSCH transmission occasions of the same TB with two TCI states used across multiple PDSCH transmission occasions as defined in Clause “Resource allocation in time domain” (for example, clause 5.1.2.1) in TS 38.214. When one TCI state is indicated in a DCI with ‘Transmission Configuration Indication’ field, the UE may expect to receive multiple slot level PDSCH transmission occasions of the same TB with one TCI state used across multiple PDSCH transmission occasions as defined in Clause “Resource allocation in time domain” (for example, clause 5.1.2.1) in TS 38.214.

When a UE is not indicated with a DCI that DCI field “Time domain resource assignment’ indicating an entry in pdsch-TimeDomainAllocationList which contain RepNumR16 in PDSCH-TimeDomainResourceAllocation, and it is indicated with two TCI states in a codepoint of the DCI field ‘Transmission Configuration Indication’ and DM-RS port(s) within two CDM groups in the DCI field “Antenna Port(s)”, the UE may expect to receive a single PDSCH where the association between the DM-RS ports and the TCI states are as defined in Clause “DMRS reception procedure” (for example, clause 5.1.6.2) in TS 38.214.

When a UE is not indicated with a DCI that DCI field “Time domain resource assignment’ indicating an entry in pdsch-TimeDomainAllocationList which contain RepNumR16 in PDSCH-TimeDomainResourceAllocation, and it is indicated with one TCI states in a codepoint of the DCI field ‘Transmission Configuration Indication’, the UE procedure for receiving the PDSCH upon detection of a PDCCH follows Clause “UE procedure for receiving the physical downlink shared channel” (for example, Clause 5.1) in TS 38.214.

In the following, the terms “FDMSchemeA” and “Scheme 2a” can be used interchangeably. The terms “FDMSchemeB” and “Scheme 2b” can be used interchangeably. The terms “TDMSchemeA” and “Scheme 3” can be used interchangeably. The terms “RepNumR16” and “Scheme 4” can be used interchangeably.

As specified in the 3GPP specifications (TS 38.214), when a UE is configured by the higher layer parameter RepSchemeEnabler set to ‘TDMSchemeA’ and indicated DM-RS port(s) within one CDM group in the DCI field “Antenna Port(s)”, the number of PDSCH transmission occasions is derived by the number of TCI states indicated by the DCI field ‘Transmission Configuration Indication’ of the scheduling DCI. If two TCI states are indicated by the DCI field ‘Transmission Configuration Indication’, the UE is expected to receive two PDSCH transmission occasions, where the first TCI state is applied to the first PDSCH transmission occasion and resource allocation in time domain for the first PDSCH transmission occasion follows Clause “Resource allocation in time domain” (for example, clause 5.1.2.1) in TS 38.214. The second TCI state is applied to the second PDSCH transmission occasion, and the second PDSCH transmission occasion shall have the same number of symbols as the first PDSCH transmission occasion. If the UE is configured by the higher layers with a value K̅ in StartingSymbolOffsetK, it shall determine that the first symbol of the second PDSCH transmission occasion starts after K̅ symbols from the last symbol of the first PDSCH transmission occasion. If the value K̅ is not configured via the higher layer parameter StartingSymbolOffsetK, K̅=0 shall be assumed by the UE. The UE is not expected to receive more than two PDSCH transmission layers for each PDSCH transmission occasion. For two PDSCH transmission occasions, the redundancy version to be applied is derived according to Table 5.1.2.1-2 in TS 38.214, where n=0, 1 applied respectively to the first and second TCI state. Otherwise, the UE is expected to receive a single PDSCH transmission occasion, and the resource allocation in the time domain follows Clause “Resource allocation in time domain” (for example, clause 5.1.2.1) in TS 38.214.

As specified in the 3GPP specifications (TS 38.214), when a UE configured by the higher layer parameter PDSCH-config that indicates at least one entry in pdsch-TimeDomainAllocationList contain RepNumR16 in PDSCH-TimeDomainResourceAllocation. If two TCI states are indicated by the DCI field ‘Transmission Configuration Indication’ together with the DCI field “Time domain resource assignment’ indicating an entry in pdsch-TimeDomainAllocationList which contain RepNumR16 in PDSCH-TimeDomainResourceAllocation and DM-RS port(s) within one CDM group in the DCI field “Antenna Port(s)”, the same SLIV (Start and length indicator value) is applied for all PDSCH transmission occasions, the first TCI state is applied to the first PDSCH transmission occasion and resource allocation in time domain for the first PDSCH transmission occasion follows Clause “Resource allocation in time domain” (for example, clause 5.1.2.1) in TS 38.214. When the value indicated by RepNumR16 in PDSCH-TimeDomainResourceAllocation equals to two, the second TCI state is applied to the second PDSCH transmission occasion. When the value indicated by RepNumR16 in PDSCH-TimeDomainResourceAllocation is larger than two, the UE may be further configured to enable CycMapping or SeqMapping in RepTCIMapping. When CycMapping is enabled, the first and second TCI states are applied to the first and second PDSCH transmission occasions, respectively, and the same TCI mapping pattern continues to the remaining PDSCH transmission occasions. When SeqMapping is enabled, first TCI state is applied to the first and second PDSCH transmissions, and the second TCI state is applied to the third and fourth PDSCH transmissions, and the same TCI mapping pattern continues to the remaining PDSCH transmission occasions. The UE may expect that each PDSCH transmission occasion is limited to two transmission layers. For all PDSCH transmission occasions associated with the first TCI state, the redundancy version to be applied is derived according to Table 5.1.2.1-2 [TS 38.214], where n is counted only considering PDSCH transmission occasions associated with the first TCI state. The redundancy version for PDSCH transmission occasions associated with the second TCI state is derived according to Table 5.1.2.1-3 [TS 38.214], where additional shifting operation for each redundancy version rvₛ is configured by higher layer parameter RVSeqOffset and n is counted only considering PDSCH transmission occasions associated with the second TCI state. If one TCI state is indicated by the DCI field ‘Transmission Configuration Indication’ together with the DCI field “Time domain resource assignment’ indicating an entry in pdsch-TimeDomainAllocationList which contain RepNumR16 in PDSCH-TimeDomainResourceAllocation and DM-RS port(s) within one CDM group in the DCI field “Antenna Port(s)”, the same SLIV is applied for all PDSCH transmission occasions, the first PDSCH transmission occasion follows Clause “Resource allocation in time domain” (for example, clause 5.1.2.1) in TS 38.214, the same TCI state is applied to all PDSCH transmission occasions. The UE may expect that each PDSCH transmission occasion is limited to two transmission layers. For all PDSCH transmission occasions, the redundancy version to be applied is derived according to Table 5.1.2.1-2 [TS 38.214], where n is counted considering PDSCH transmission occasions. Otherwise, the UE is expected to receive a single PDSCH transmission occasion, and the resource allocation in the time domain follows Clause “Resource allocation in time domain” (for example, clause 5.1.2.1) in TS 38.214.

TABLE 5.1.2.1-2
Applied redundancy version when pdsch-
AggregationFactor is present

| rv_{id} indicated by the | rv_{id} to be applied to n^{th} transmission occasion | | | |
|---|---|---|---|---|
| DCI scheduling the | n mod | n mod | n mod | n mod |
| PDSCH | 4 = 0 | 4 = 1 | 4 = 2 | 4 = 3 |
| 0 | 0 | 2 | 3 | 1 |
| 2 | 2 | 3 | 1 | 0 |
| 3 | 3 | 1 | 0 | 2 |
| 1 | 1 | 0 | 2 | 3 |

TABLE 5.1.2.1-3
Applied redundancy version for the second
TCI state when RVSeqOffset is present

| rv_{id} | | | | |
|---|---|---|---|---|
| indicated | | | | |
| by the DCI | | | | |
| scheduling | rv_{id} to be applied to n^{th} transmission occasion with second TCI state | | | |
| the PDSCH | n mod 4 = 0 | n mod 4 = 1 | n mod 4 = 2 | n mod 4 = 3 |
| 0 | (0 + rvₛ) mod 4 | (2 + rvₛ) mod 4 | (3 + rvₛ) mod 4 | (1 + rvₛ) mod 4 |
| 2 | (2 + rvₛ) mod 4 | (3 + rvₛ) mod 4 | (1 + rvₛ) mod 4 | (0 + rvₛ) mod 4 |
| 3 | (3 + rvₛ) mod 4 | (1 + rvₛ) mod 4 | (0 + rvₛ) mod 4 | (2 + rvₛ) mod 4 |
| 1 | (1 + rvₛ) mod 4 | (0 + rvₛ) mod 4 | (2 + rvₛ) mod 4 | (3 + rvₛ) mod 4 |

As specified in the 3GPP specifications (TS 38.214), For a UE configured by the higher layer parameter RepSchemeEnabler set to ‘FDMSchemeA’ or ‘FDMSchemeB’, and when the UE is indicated with two TCI states in a codepoint of the DCI field ‘Transmission Configuration Indication and DM-RS port(s) within one CDM group in the DCI field “Antenna Port(s)”. If P′_{BWP,i}, is determined as “wideband”, the first

$$⌈ \frac{{n}_{PRB}}{2} ⌉$$

PRBs are assigned to the first TCI state and the remaining

$$⌊ \frac{{n}_{PRB}}{2} ⌋$$

PRBs are assigned to the second TCI state, where n_{PRB} is the total number of allocated PRBs for the UE. If P′_{BWP,i} is determined as one of the values among {2, 4}, even PRGs within the allocated frequency domain resources are assigned to the first TCI state and odd PRGs within the allocated frequency domain resources are assigned to the second TCI state. The UE is not expected to receive more than two PDSCH transmission layers for each PDSCH transmission occasion.

For a UE configured by the higher layer parameter RepSchemeEnabler set to ‘FDMSchemeB’, and when the UE is indicated with two TCI states in a codepoint of the DCI field ‘Transmission Configuration Indication and DM-RS port(s) within one CDM group in the DCI field “Antenna Port(s)”, each PDSCH transmission occasion shall follow the Clause “Physical downlink shared channel” (for example Clause 7.3.1) of [TS 38.211] with the mapping to resource elements determined by the assigned PRBs for corresponding TCI state of the PDSCH transmission occasion, and the UE shall only expect at most two code blocks per PDSCH transmission occasion when a single transmission layer is scheduled and a single code block per PDSCH transmission occasion when two transmission layers are scheduled. For two PDSCH transmission occasions, the redundancy version to be applied is derived according to Table 5.1.2.1-2 of [TS 38.214], where n=0, 1 are applied to the first and second TCI state, respectively.

In some embodiments, the terminal device 130 may be configured with a first PDCCH candidate and a second PDCCH candidate, where the first PDCCH candidate and the second PDCCH candidate are linked. For example, the linked first PDCCH candidate and second PDCCH candidate are applied for PDCCH repetition. For another example, the linked first PDCCH candidate and second PDCCH candidate are applied for same scheduling. For example, the scheduling may be at least one of downlink data scheduling, PDSCH scheduling, uplink data scheduling, PUSCH scheduling, downlink RS scheduling, uplink RS scheduling and PUCCH scheduling.

In some embodiments, the terminal device 130 may be configured with multiple control resource sets (i.e. CORESET).

In some embodiments, a CORESET may consist of N_{RB}^{CORESET} resource blocks (RBs) in the frequency domain and N_{symb}^{CORESET} ∈{1,2,3}symbols in the time domain. In some embodiments, a control-channel element (CCE) consists of 6 resource-element groups (REGs) where a REG equals to one resource block during one orthogonal frequency-division multiplexing (OFDM) symbol. In some embodiments, REGs within a control-resource set are numbered in increasing order in a time-first manner, starting with 0 for the first OFDM symbol and the lowest-numbered resource block in the control resource set.

In some embodiments, one CORESET may be associated with one or more search space sets. One search space set may include or may be associated with one or more PDCCH candidates. In some embodiments, PDCCH monitoring periodicity and/or slot offset and/or symbol index within a slot can be configured per search space set. In some embodiments, one PDCCH candidate may be associated with or may correspond to a search space.

In some embodiments, a procedure may be defined for determining physical downlink control channel candidates for the terminal device 130. That is, determining the CCE index(es) for each of a plurality of PDCCH candidates that is potentially to be used for PDCCH transmission between the network device 110 and the terminal device 130.

With the CCE index for PDCCH candidates determined, the terminal device 130 can perform blind detection on these PDCCH candidates. Once PDCCH transmission is detected or received on a PDCCH candidate, the terminal device 130 may decode it to obtain information such as DCI.

In some embodiments, the terminal device 130 may assume that a Demodulation Reference Signal (DM-RS) antenna port associated with PDCCH reception(s) in the CORESET is quasi co-located (QCLed) with the one or more reference signal (RS) configured by a transmission control indicator (TCI) state, where the TCI state is indicated for the CORESET, if any.

In some embodiments, the terminal device 130 may assume that a DM-RS antenna port associated with PDCCH reception(s) in the CORESET is quasi co-located (QCLed) with a Synchronization Signal/Physical Broadcast Channel (SS/PBCH) block the UE identified during a most recent random access procedure not initiated by a PDCCH order that triggers a contention-free random access procedure, if no Medium Access Control (MAC) control element (CE) activation command indicating a TCI state for the CORESET is received after the most recent random access procedure the one or more reference signal (RS) configured by a TCI state, where the TCI state is indicated for the CORESET, if any.

In some embodiments, the network device 110 may transmit, to the terminal device 130, a configuration (e.g. 210) indicative of N PDCCH candidates, where N is a positive integer. For example, 1≤N≤32. For another example, N=2. For example, the configuration may be transmitted via any of Radio Resource Control (RRC) signaling, Medium Access Control (MAC) control element (CE) and DCI.

In some embodiments, the network device 110 may transmit, to the terminal device 130, one or more configurations (e.g. 210) for a first PDCCH candidate and a second PDCCH candidate. In some embodiments, the first PDCCH candidate may be comprised in a first search space or a first search space set. In some embodiments, the first search space or the first search space set may be associated with a first CORESET. In some embodiments, the first CORESET may be associated or configured with a first TCI state T1 or a first set of QCL parameters Q1. In some embodiments, the second PDCCH candidate may be comprised in a second search space or a second search space set. In some embodiments, the second search space or the second search space set may be associated with a second CORESET. In some embodiments, the second CORESET may be associated or configured with a second TCI state T2 or a second set of QCL parameters Q2. In some embodiments, T1 may be different from T2. In some embodiments, Q1 may be different from Q2.

In some embodiments, the first PDCCH candidate and the second PDCCH candidate may be configured to be explicitly linked/associated together. For example, the terminal device 130 is able to know the linking/association before decoding. In some embodiments, there may be a first PDCCH/DCI transmitted/received in the first PDCCH candidate. In some embodiments, there may be a second PDCCH/DCI transmitted/received in the second PDCCH candidate. In some embodiments, the DCI payload and/or the coded bits and/or the number of CCEs in the first PDCCH/DCI are same with the second PDCCH/DCI. In some embodiments, the first PDCCH/DCI and the second PDCCH/DCI schedule a same communication between the network device 110 and the terminal device 130. For example, the communication may be at least one of PDSCH, PUSCH, Sounding Reference Signal (SRS), Channel State Information-Reference Signal (CSI-RS), transport block, an active UL BWP change, and an active DL BWP change, PUCCH.

In some embodiment, the network device 110 may transmit, to the terminal device 130, a configuration (e.g. 210) indicating the first PDCCH candidate and the second PDCCH candidate are linked together for PDCCH repetition. In some embodiment, the network device 110 may transmit, to the terminal device 130, a configuration (e.g. 210) indicating the first search space (or the first search space set or the first CORESET) and the second search space (or the second search space set or the second CORESET) are linked together. For example, the configuration can be transmitted from the network device 110 to the terminal device 130 via any of the following: Radio Resource Control (RRC) signaling, Medium Access Control (MAC) control element (CE) or DCI. For example, the first PDCCH candidate and the second PDCCH candidate can be used to carry a single or a same DCI format (or DCI payload).

In some embodiments, the first PDCCH candidate may end no later or earlier than the second PDCCH candidate in time domain.

In some embodiments, the network device 110 may transmit at least one configuration (e.g. 210) about a first CORESET and a second CORESET to the terminal device 130.

In some embodiments, the at least one configuration may configure a first set of search spaces which is associated with the first CORESET. In some embodiments, the at least one configuration may configure a second set of search spaces which is associated with the second CORESET. In some embodiments, the at least one configuration may configure a first set of PDCCH candidates in a first search space of the first set of search spaces. In some embodiments, the at least one configuration may configure a second set of PDCCH candidates in a second search space of the second set of search spaces. In some embodiments, the at least one configuration may configure that a first PDCCH candidate in the first search space of the first set of search spaces associated with the first CORESET is linked or associated or related to a second PDCCH candidate in the second search space of the second set of search spaces associated with the second CORESET. For example, the terminal device knows the linking or association or relationship before decoding the PDCCH or DCI in the first and second PDCCH candidates. In some embodiments, the first and second PDCCH candidates may be used for PDCCH repetitions. For example, encoding and/or rate matching of the PDCCH or DCI in the PDCCH in the first PDCCH candidate and/or the second PDCCH candidate is based on one repetition (for example, PDCCH or DCI in the PDCCH in one of the first and second PDCCH candidates). For example, the same coded bits are repeated for the other repetition. For another example, each repetition has the same number of control channel elements (CCEs) and coded bits, and corresponds to the same DCI payload. In some embodiments, the at least one configuration may be transmitted/received via at least one of RRC signaling, MAC CE and DCI.

In some embodiments, a PDCCH candidate in the first search space set is linked with the a PDCCH candidate in the second search space set based on the two PDCCH candidates having the same aggregation level and same candidate index. For example, the aggregation level of the first PDCCH candidate and the aggregation level of the second PDCCH candidate are same. For another example, the candidate index of the first PDCCH candidate and the candidate index of the second PDCCH candidate are same.

In some embodiments, the network device 110 may transmit one or more configurations (e.g. 210) of a third CORESET to the terminal device 130. The one or more configurations may indicate two active TCI states for the third CORESET. For example, the terminal device 130 may detect/decode PDCCH in the search space sets which associated with the third CORESET with the two active TCI states.

In some embodiments, the network device 110 may transmit one or more configurations (e.g. 210) for a first number of PDSCH/PUSCH/PUCCH transmissions/receptions/repetitions/occasions to the terminal device 130. For example, the first number is denoted as G. For example, 1≤G≤32. For another example, G may be at least one of {1,2,3,4,5,6,7,8,16,32}. In some embodiments, the network device 110 may transmit a scheduling (e.g. 210) for the first number of PDSCH/PUSCH/PUCCH transmissions/receptions/repetitions/occasions in a single DCI/PDCCH or in PDCCH in linked PDCCH candidates to the terminal device 130. In some embodiments, there may be two TCI states (e.g. first TCI state and second TCI state) or two spatial relation info (e.g. first spatial relation info and a second spatial relation info) indicated/configured in the single DCI/PDCCH or in the PDCCH in linked PDCCH candidates.

In some embodiments, the terminal device 130 may be configured or indicated with M activated unified TCI states. For example, the unified TCI states may be downlink TCI states or joint TCI states. M can be a positive integer. For example, M may be at least one of {1, 2, 3, 4}.

In some embodiments, the terminal device 130 may be configured or indicated with N activated unified TCI states. For example, the unified TCI states may be uplink TCI states or joint TCI states. N can bea positive integer. For example, N may be at least one of {1, 2, 3, 4}.

In some embodiments, if M≥2, there may be two sets of PDSCH/PUSCH/PUCCH transmissions/receptions/repetitions/occasions for the plurality of PDSCH/PUSCH/PUCCH transmissions/receptions/repetitions/occasions (e.g., set 1 and set 2), and set 1 with a second number of PDSCH/PUSCH/PUCCH transmissions/receptions/repetitions/occasions (second number is G1, G1 is a positive integer, e.g. G1=G/2 or G1=ceil(G/2) or G1=floor(G/2)), and set 2 with a third number of PDSCH/PUSCH/PUCCH transmissions/receptions/repetitions/occasions (third number is G2, and G2=G−G1). In some embodiments, the set 1 of PDSCH/PUSCH/PUCCH transmissions/receptions/repetitions/occasions is transmitted/received with the first TCI state or the first spatial relation info, and the set 2 of PDSCH/PUSCH/PUCCH transmissions/receptions/repetitions/occasions is transmitted/received with the second TCI state or the second spatial relation information.

In some embodiments, the network device 110 may configure (e.g. 210) a mapping type to the terminal device 130. For example, the mapping type may indicate the association between the TCI states and the PDSCH/PUSCH/PUCCH transmissions/receptions/repetitions/occasions. In some embodiments, the network device 110 may configure (e.g. 210) cyclic mapping type to the terminal device 130, and the network device may configure the first number of PDSCH/PUSCH/PUCCH transmissions/receptions/repetitions/occasions to be larger than 2. And the first and second TCI states are applied to the first and second PDSCH/PUSCH/PUCCH transmissions/receptions/repetitions/occasions, respectively, and the same TCI mapping pattern continues to the remaining PDSCH/PUSCH/PUCCH transmissions/receptions/repetitions/occasions. In some embodiments, the network device 110 may configure (e.g. 210) sequential mapping type to the terminal device 130, and the network device may configure the first number of PDSCH/PUSCH/PUCCH transmissions/receptions/repetitions/occasions to be larger than 2. And the first TCI state is applied to the first and second PDSCH/PUSCH/PUCCH transmissions/receptions/repetitions/occasions, and the second TCI state is applied to the third and/or fourth PDSCH/PUSCH/PUCCH transmissions/receptions/repetitions/occasions, and same TCI mapping pattern continues to the remaining PDSCH/PUSCH/PUCCH transmissions/receptions/repetitions/occasions. In some embodiments, the network device 110 may configure (e.g. 210) the first number of PDSCH/PUSCH/PUCCH transmissions/receptions/repetitions/occasions to be 2. And the first TCI state is applied to the first PDSCH/PUSCH/PUCCH transmission/reception/repetition/occasion, and the second TCI state is applied to the second PDSCH/PUSCH/PUCCH transmission/reception/repetition/occasion.

When a UE configured by the higher layer parameter repetitionScheme set to ‘fdmSchemeA’ or ‘fdmSchemeB’, and the UE is indicated with two TCI states in a codepoint of the DCI field ‘Transmission Configuration Indication’ and DM-RS port(s) within one CDM group in the DCI field ‘Antenna Port(s)’, the UE shall receive a single PT-RS port which is associated with the lowest indexed DM-RS antenna port among the DM-RS antenna ports assigned for the PDSCH, a PT-RS frequency density is determined by the number of PRBs associated to each TCI state, and a PT-RS resource element mapping is associated to the allocated PRBs for each TCI state.

In addition to normal data communications, the network device 110 may send a RS to the terminal device 130 in a downlink. Similarly, the terminal device 130 may transmit a RS to the network device 110 in an uplink. Generally speaking, a RS is a signal sequence (also referred to as “RS sequence”) that is known by both the network device 110 and the terminal devices 130. For example, a RS sequence may be generated and transmitted by the network device 110 based on a certain rule and the terminal device 130 may deduce the RS sequence based on the same rule. For another example, a RS sequence may be generated and transmitted by the terminal device 130 based on a certain rule and the network device 110 may deduce the RS sequence based on the same rule. Examples of the RS may include but are not limited to downlink or uplink Demodulation Reference Signal (DMRS), CSI-RS, Sounding Reference Signal (SRS), Phase Tracking Reference Signal (PTRS), Tracking Reference Signal (TRS), fine time-frequency Tracking Reference Signal (TRS), CSI-RS for tracking, Positioning Reference Signal (PRS) and so on.

In addition to normal data communications, the network device 110 may transmit DCI via a PDCCH to the terminal device 130. The DCI may indicate resource allocation for data transmission in a DL or UL. Concurrently, a DMRS associated with the PDCCH may also be transmitted from the network device 110 to the terminal device 130. The DMRS may be used by the terminal device 130 for channel demodulation. Then, the terminal device 130 may attempt to blindly decode the DCI in a PDCCH in a search space which is associated with a control resource set (CORESET). As used herein, a “CORESET” and/or a search space refers to a set of resource element groups (REGs) within which the terminal device attempts to blindly decode the DCI. A search space indicating the start time and a periodicity for monitoring a PDCCH in the CORESET may be indicated to the terminal device 130. In response to decoding the DCI successfully, the terminal device 130 may perform the UL and/or DL data transmission (for example, data transmission via PDSCH and/or Physical Uplink Shared Channel (PUSCH)) with the network device 110 accordingly.

The network device 110 may communicate data and control information to the terminal device 130 via a plurality of beams (also referred to as “DL beams”). The terminal device 130 may also communicate data and control information to the network device 110 via a plurality of beams (also referred to as “UL beams”). In 3GPP specifications for new radio (NR), a beam is also defined and indicated by parameters of a transmission configuration indicator. For example, there may be a transmission configuration indication (TCI) field in DCI. A value of the TCI field may be referred to as a “TCI codepoint”. A TCI codepoint may indicate one or more TCI states. Each TCI state contains parameters for configuring a quasi co-location (QCL) relationship between one or two DL and/or UL reference signals and the DMRS ports of the PDSCH, the DMRS ports of PDCCH, the DMRS ports of PUSCH, the DMRS ports of PUCCH, the SRS ports of a SRS resource or the CSI-RS ports of a CSI-RS resource.

In some embodiments, there may be an application timing for beam indication or TCI state(s) indication. In some embodiments, the application timing may be the first slot or the first subslot that is at least Y symbols after the last symbol of acknowledge of the joint or separate DL/UL beam indication or TCI state indication. For example, Y may be an integer, and 1<=Y<=336. In some embodiments, a slot may include 12 or 14 symbols. In some embodiments, a subslot may include S symbols. In some embodiments, S can be an integer, and 1<=S<=14. For example, S may be at least one of {2, 4, 7}. In some embodiments, the TCI state is indicated in a DCI in a PDCCH. For example, the DCI in the PDCCH may schedule a PDSCH or may not schedule a PDSCH. In some embodiments, the gap between the last symbol of the DCI and the first slot or the first subslot shall satisfy the capability for the terminal device. In some embodiments, the acknowledge of the joint or separate DL/UL beam indication may be the acknowledge of the PDSCH scheduled by the DCI, for example, when the DCI schedules the PDSCH. In some embodiments, the acknowledge of the joint or separate DL/UL beam indication may be the acknowledge of the DCI, for example, when the DCI doesn't schedule a PDSCH.

In some embodiments, a DCI (for example, DCI format 1_1/1_2 with and without DL assignment) may be used for dynamic beam indication. In some embodiments, a DCI with DL scheduling or PDSCH scheduling may indicate a TCI state, and HARQ or ACK and/or NACK for the PDSCH or DL scheduling can be used to indicate acknowledgement of the TCI state indication. And after an application timing, the indicated TCI state may be applied. For example, the indicated TCI state can be applied to PDSCH and/or PDCCH and/or PUSCH and/or PUCCH and/or downlink RS and/or uplink RS.

In some embodiments, the terminal device 130 may receive or detect a DCI (for example, represented as “DCI_t”) in a PDCCH, and the DCI indicates a joint DL/UL TCI state or a separate DL/UL TCI state or a DL TCI state or a UL TCI state or a pair of DL/UL TCI states. In some embodiments, a first time threshold may indicate a predetermined/configured time period after the first or last symbol of the PDCCH or the first or last symbol of the acknowledge of the indication. In some embodiments, the indicated joint DL/UL TCI state or separate DL/UL TCI state or DL TCI state or UL TCI state or the pair of DL/UL TCI states may be applied to PDSCH and/or CORESET and/or PUSCH and/or PUCCH and/or uplink RS and/or downlink RS after the application timing or the first time threshold. For example, when a joint DL/UL TCI state is indicated in the DCI, the joint DL/UL TCI state may be applied to PDSCH and/or CORESET and/or PUSCH and/or PUCCH and/or uplink RS and/or downlink RS after the application timing or the first time threshold. As another example, when a DL TCI state is indicated in the DCI, the DL TCI state may be applied to PDSCH and/or CORESET and/or downlink RS after the application timing or the first time threshold. As another example, when an UL TCI state is indicated in the DCI, the UL TCI state may be applied to PUSCH and/or PUCCH and/or uplink RS after the application timing or the first time threshold. As another example, when a pair of DL/UL TCI states is indicated in the DCI, the DL TCI state may be applied to PDSCH and/or CORESET and/or downlink RS after the application timing or the first time threshold, and the UL TCI state may be applied to PUSCH and/or PUCCH and/or uplink RS after the application timing or the first time threshold. In some embodiments, the first time threshold may be same with the threshold.

In some embodiments, the terminal device 130 may receive an indication of TCI state(s) in a DCI. In some embodiments, the terminal device 130 may transmit a PUCCH with HARQ-ACK information corresponding to the DCI carrying the indication (for example, the DCI may be without DL assignment) and/or corresponding to a PDSCH scheduled by the DCI carrying the indication (for example, the DCI may be with DL assignment), the indicated TCI state(s) may be applied starting from an application timing for the indicated TCI state(s). In some embodiments, the application timing may be the first slot that is at least Y symbols after the last symbol of the PUCCH. For example, the HARQ-ACK information may be ACK or acknowledge. In some embodiments, the indicated TCI state(s) may be applied if at least one of the indicated TCI state(s) is different from at least one of the previously indicated TCI states.

In some embodiments, the terminal device 130 may receive an indication of a TCI state in a DCI. For example, the TCI state may be a joint TCI state. In some embodiments, the terminal device 130 may transmit a PUCCH with HARQ-ACK information corresponding to the DCI carrying the indication (for example, the DCI may be without DL assignment) and/or corresponding to a PDSCH scheduled by the DCI carrying the indication (for example, the DCI may be with DL assignment), the indicated TCI state may be applied starting from an application timing for the indicated TCI state. In some embodiments, the application timing may be the first slot that is at least Y symbols after the last symbol of the PUCCH. For example, the HARQ-ACK information may be ACK or acknowledge. In some embodiments, the indicated TCI state may be applied if the indicated TCI state is different from the previously indicated TCI state.

In some embodiments, the terminal device 130 may receive an indication of a DL TCI state and/or a UL TCI state in a DCI. In some embodiments, the terminal device 130 may transmit a PUCCH with HARQ-ACK information corresponding to the DCI carrying the indication (For example, the DCI may be without DL assignment) and/or corresponding to a PDSCH scheduled by the DCI carrying the indication (for example, the DCI may be with DL assignment), the indicated DL TCI state and/or UL TCI state may be applied starting from an application timing for the indicated DL TCI state and/or UL TCI state. In some embodiments, the application timing may be the first slot that is at least Y symbols after the last symbol of the PUCCH. For example, the HARQ-ACK information may be ACK or acknowledge. In some embodiments, the indicated DL TCI state and/or UL TCI state may be applied if the indicated DL TCI state is different from the previously indicated DL TCI state and/or if the indicated UL TCI state is different from the previously indicated UL TCI state.

In some embodiments, a DCI indicating at least one of a semi-persistent (SPS) PDSCH release, secondary cell (Scell) dormancy without scheduling a PDSCH reception, indicating a TCI state update without scheduling PDSCH reception may be referred to as a DCI having associated HARQ-ACK information without scheduling a PDSCH reception.

In some embodiments, the HARQ-ACK information may include more than one HARQ-ACK information bit.

In some embodiments, for a HARQ-ACK information bit, the terminal device 130 may generate a positive acknowledgement (ACK) if the terminal device 130 detects a DCI or correctly decodes a transport block or a code block group (CBG), wherein the DCI may provide a SPS PDSCH release or indicate a TCI state update.

In some embodiments, for a HARQ-ACK information bit, the terminal device 130 may generate a negative acknowledgement (NACK) if the terminal device 130 does not correctly decode a transport block or a code block group (CBG). In some embodiments, a HARQ-ACK information bit value of 0 may represent a NACK. In some embodiments, a HARQ-ACK information bit value of 1 may represent an ACK.

In some embodiments, the terminal device 130 may be configured with a transmission of code block group. For example, the terminal device 130 may be provided or configured with PDSCH-CodeBlockGroupTransmission for a serving cell. In some embodiments, the terminal device 130 may receive a PDSCH scheduled by a DCI (for example, DCI format 1_1 or DCI format 1_2). In some embodiments, there may be one or two transport blocks in the PDSCH. In some embodiments, there may be more than one code block group (CBG) or code block (CB) in the transport block or in one of the two transport blocks. In some embodiments, the terminal device 130 may be provided or configured with a maximum number of CBGs. For example, the maximum number may be represented as N_{HARQ-ACK}^{CBG/TB, max}. For example, the value of N_{HARQ-ACK}^{CBG/TB, max} may be at least one of {2, 4, 6, 8}. In some embodiments, the terminal device 130 may generate N_{HARQ-ACK}^{CBG/TB, max} HARQ-ACK information bits for a transport block.

In some embodiments, there may be a number of code blocks (CBs) (for example, the number may be represented as C, and C is a positive integer) in a transport block, and the terminal device 130 may determine a number of CBGs (for example, the number may be represented as N_CBG) for the transport block. For example, N_CBG is a positive integer. In some embodiments, N_CBG is a minimum value between N_{HARQ-ACK}^{CBG/TB, max} and C. For example, N_CBG=min(N_{HARQ-ACK}^{CBG/TB, max}, C). In some embodiments, there may be at least one code block (CB) in a CBG.

In some embodiments, the terminal device 130 may determine a number of HARQ-ACK information bits for the transport block. For example, the number may be represented as N_{HARQ-ACK}^{CBG/TB}. For example, N_{HARQ-ACK}^{CBG/TB}=M.

In some embodiments, the terminal device 130 may generate an ACK for the HARQ-ACK information bit of a CBG if the terminal device 130 correctly received or decoded all code blocks of the CBG. In some embodiments, the terminal device 130 may generate a NACK for the HARQ-ACK information bit of a CBG if the terminal device 130 incorrectly received or decoded at least one code block of the CBG. In some embodiments, if the terminal device 130 receives two transport blocks, the terminal device 130 may concatenate the HARQ-ACK information bits for CBGs of the second transport block after the HARQ-ACK information bits for CBGs of the first transport block.

In some embodiments, the HARQ-ACK codebook may include the N_{HARQ-ACK}^{CBG/TB, max} HARQ-ACK information bits. In some embodiments, if N_{HARQ-ACK}^{CBG/TB}<N_{HARQ-ACK}^{CBG/TB, max} for a transport block, the terminal device 130 may generate a NACK value for (each of) the last N_{HARQ-ACK}^{CBG/TB, max}−N_{HARQ-ACK}^{CBG/TB} information bits for the transport block in the HARQ-ACK codebook.

In some embodiments, if the terminal device 130 generates a HARQ-ACK codebook in response to a retransmission of a transport block, corresponding to a same HARQ process as a previous transmission of the transport block, the terminal device 130 may generate an ACK for each CBG that the terminal device 130 correctly decoded in a previous transmission of the transport block.

In some embodiments, if the terminal device 130 correctly detects or decodes each of the N_{HARQ-ACK}^{CBG/TB} CBGs and does not correctly detect or decodes the transport block for the N_{HARQ-ACK}^{CBG/TB} CBGs, the terminal device 130 may generate a NACK value for each of the N_{HARQ-ACK}^{CBG/TB} CBGs.

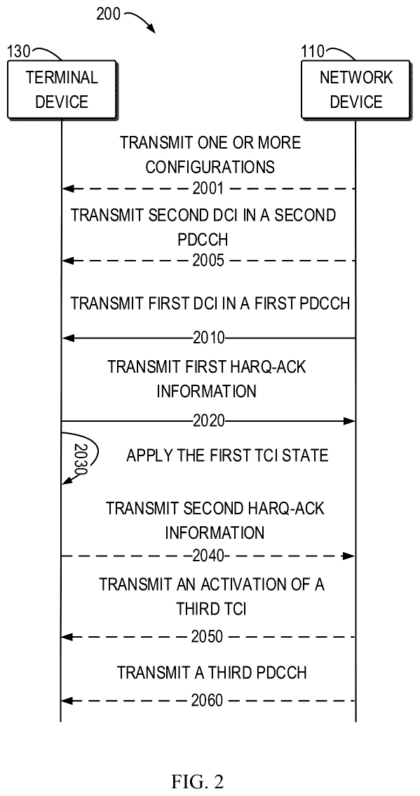

FIG. 2 illustrates a signaling chart for signaling communication in accordance with some embodiments of the present disclosure. For the purpose of discussion, the process 200 will be described with reference to FIG. 1. The process 200 may involve the network device 110 and the terminal device 130 as shown in FIG. 1. In some embodiments, the process 200 may also involve the TRP 120-1 and TRP 120-2 and the terminal device 130 as shown in FIG. 1.

In some embodiments, for example, as shown in FIG. 2, the network device 110 may configure/transmit 2001 one or more configurations to the terminal device 130. In some embodiments, the one or more configurations may include at least one of configuration of TCI state(s), configuration of CORESET, configuration of search space, configuration of PDCCH, configuration of PDSCH, configuration of PUSCH, configuration of PUCCH, configuration of control information for data transmission/reception, configuration of reference signal (RS) transmission/reception, configuration of repetition/transmission/reception scheme.

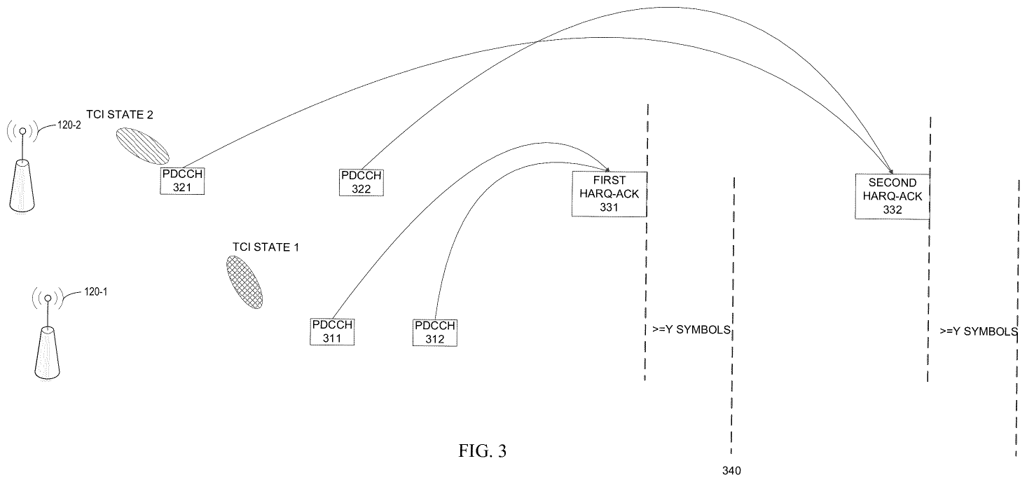

The network device 110 transmits 2010 a first PDCCH to the terminal device 130. The first PDCCH comprises first DCI. The first DCI indicates a first TCI state. In some embodiments, the first PDCCH can be received from the TRP 120-1. For example, as shown in FIG. 3, the TRP 120-1 may transmit the PDCCH 311 to the terminal device 130. The PDCCH 311 may comprise the first DCI which indicates the TCI state 1.

In some embodiments, before the transmission of the first PDCCH, the network device 110 may transmit 2005 a second PDCCH to the terminal device 130. The second PDCCH comprises second DCI. The second DCI indicates a second TCI state. In some embodiments, the second PDCCH can be received from the TRP 120-2. For example, as shown in FIG. 3, the TRP 120-2 may transmit the PDCCH 321 to the terminal device 130. The PDCCH 321 may comprise the second DCI which indicates the TCI state 2.

The terminal device 130 transmits 2020 first HARQ-ACK information to the network device 110. The first HARQ-ACK information corresponds to the first DCI in the first PDCCH. In some embodiments, the first HARQ-ACK information can be transmitted to the TRP 120-1. For example, as shown in FIG. 3, the TRP 120-1 may receive the HARQ-ACK information 331 from the terminal device 130. The HARQ-ACK information 331 may correspond to the DCI in the PDCCH 311.

In some embodiments, the terminal device 130 may transmit 2040 second HARQ-ACK information to the network device 110. The second HARQ-ACK information corresponds to the second DCI in the second PDCCH. In some embodiments, the second HARQ-ACK information can be transmitted to the TRP 120-2. For example, as shown in FIG. 3, the TRP 120-2 may receive the HARQ-ACK information 332 from the terminal device 130. The HARQ-ACK information 332 may correspond to the DCI in the PDCCH 321.

Referring back to FIG. 2, if a condition is fulfilled, the terminal device 130 applies 2030 the first TCI state. For example, as shown in FIG. 3, the terminal device 130 can apply the TCI state 1 at the timing 340. There can be more than Y symbols between the HARQ-ACK information 331 and the timing 340. In some embodiments, the terminal device 130 may apply the first TCI state to all PUCCHs. Alternatively, the terminal device 130 may apply the first TCI state to a subset of PUCCHs. For example, some PUCCHs (for example, presented as PUCCH_na) can be configured to apply or not apply the indicated TCI state. In some embodiments, not applying the first TCI state may be configured conditioned on when a CORESET is configured to not apply the indicated TCI state. The PUCCH not applying the indicated TCI state may be applied for HARQ-ACK feedback for PDSCH scheduled by the CORESET (not applying the indicated TCI state).

In some embodiments, the timing to apply the first TCI state or the timing for the application (2030) may be later than or no earlier than the timing or the first/starting symbol or the last/ending symbol for transmission of the second HARQ-ACK information.

In some embodiments, the timing to apply the first TCI state or the timing for the application (2030)may be earlier than the timing or the first/starting symbol or the last/ending symbol for transmission of the second HARQ-ACK information.

In some embodiments, the condition can comprise that at least one bit value of the HARQ-ACK information corresponding to the first DCI or corresponding to a PDSCH scheduled by the first DCI is ACK. Table 1 below shows an example according to some embodiments.

TABLE 1
When the UE would transmit the last symbol of a PUCCH with HARQ-ACK information
corresponding to the DCI carrying the TCI-State indication and without DL assignment, or
corresponding to the PDSCH scheduling by the DCI carrying the TCI -State indication, and if the
indicated TCI-State is different from the previously indicated one, and if at least one bit of the HARQ-
ACK information corresponding to the DCI or the PDSCH scheduling by the DCI is ACK, the
indicated [TCI-State] with [tci-StateId_r17] should be applied starting from the first slot that is at least
BeamAppTime_r17 symbols after the last symbol of the PUCCH. The first slot and the
BeamAppTime_r17 symbols are both determined on the carrier with the smallest SCS among the
carrier(s) applying the beam indication. The UE can assume one indicated [TCI-State] with [tci-
StateId_r17] for DL and UL, for DL only, or for UL only at a time.

In some embodiments, the terminal device 130 may receive or detect a DCI, and the DCI may indicate a unified TCI state, and the DCI may schedule at least one PDSCH. In some embodiments, there may be two transport blocks in the PDSCH. In some embodiments, there may be at least one CBG in a transport block in the PDSCH. In some embodiments, there may be at least one CBG in at least one of the two transport blocks in the PDSCH. In some embodiments, there may be at least one HARQ-ACK information bit in the HARQ-ACK information for the PDSCH. In some embodiments, if at least one HARQ-ACK information bit for the PDSCH scheduled by the DCI is ACK and/or if the unified TCI state is different from a previous indicated/applied unified TCI state, the unified TCI state is applied after the application timing. In some embodiments, if any one HARQ-ACK information bit for the PDSCH scheduled by the DCI is NACK, the unified TCI state is not applied after the application timing.

In some embodiments, the condition can comprise that the first TCI state is configured for TCI update in unified TCI framework. Alternatively or in addition, the condition can comprise that the first TCI state is a unified TCI state. In some embodiments, the condition can comprise that the first TCI state is configured with tci-StateId-r17. In some embodiments, the condition may comprise that the first TCI state is labelled with a parameter, wherein the parameter is tci-StateId-r17 or r17. In some other embodiments, the condition can comprise that the first TCI state is different from a seventh TCI state. The seventh TCI state can be at least one of: a previous applied unified TCI state, a previous indicated unified TCI state, or a current applied unified TCI state.

In some embodiments, the condition can comprise that the first DCI is not a DCI scheduling semi-persistent scheduling (SPS) activation. Alternatively or in addition, the condition may comprise that the first DCI is not a DCI scheduling SPS release. In some other embodiments, the condition can comprise that the first DCI is a DCI carrying a unified TCI state or a TCI state for TCI state update or a TCI state configured with tci-StateId-r17. In some embodiments, the condition can comprise that the first PDCCH is not a PDCCH in a control resource set (CORESET) which is not configured to share or apply the unified TCI state. Alternatively or in addition, the condition can comprise that the first PDCCH is a PDCCH in a CORESET which is configured to share or apply the unified TCI state. Table 2 below shows an example according to some embodiments.

TABLE 2
When the UE would transmit the last symbol of a PUCCH with HARQ-ACK information
corresponding to the DCI carrying the TCI-State indication and without DL assignment, or
corresponding to the PDSCH scheduling by the DCI carrying the TCI -State indication, and if the
indicated TCI-State is different from the previously indicated one, and the DCI is not in a PDCCH
scheduling SPS activation and/or scheduling SPS release and/or not in a PDCCH in a CORESET which
is not configured to share/apply the indicated [TCI-State] with [tci-StateId_r17]. the indicated [TCI-
State] with [tci-StateId_r17] should be applied starting from the first slot that is at least
BeamAppTime_r17 symbols after the last symbol of the PUCCH. The first slot and the
BeamAppTime_r17 symbols are both determined on the carrier with the smallest SCS among the
carrier(s) applying the beam indication. The UE can assume one indicated [TCI-State] with [tci-
StateId_r17] for DL and UL, for DL only, or for UL only at a time.

In some embodiments, the terminal device 130 may receive or detect a DCI, and the DCI may schedule at least one of an SPS scheduling activation, an SPS release and an Scell dormancy, the value in the TCI field (if exists) in the DCI may be ignored or the indicated TCI state in the TCI field may not be applied or may be ignored. For example, the DCI may not schedule a PDSCH reception. For another example, the DCI may schedule a PDSCH reception.

In some embodiments, the terminal device 130 may be configured with a CORESET. In some embodiments, the CORESET may be configured to not share or not apply the indicated unified TCI state or the indicated TCI state for PDCCH and/or PDSCH. In some embodiments, the CORESET may not be configured with an indication or a configuration to share or to apply the indicated unified TCI state. In some embodiments, there may be a TCI field in a DCI in a PDCCH in the CORESET. In some embodiments, the terminal device 130 may receive or detect the DCI, and the value in the TCI field (if exists) in the DCI may be ignored or the indicated TCI state in the TCI field may not be applied or may be ignored.

In some embodiments, the HARQ-ACK information may comprise more than one HARQ-ACK information bit. Alternatively or in addition, the PDSCH may comprise two transport blocks. In this case, each transport block can correspond to one HARQ-ACK information bit. In some other embodiments, the PDSCH may comprise one transport block. In some embodiments, the least one transport block in the PDSCH may comprise more than one code block groups (CBGs). In this case, each CBG can correspond to one HARQ-ACK information bit.

In some embodiments, as mentioned above, the terminal device 130 can receive the first PDCCH and the second PDCCH. In this case, the condition can comprise that the transmission of the first HARQ-ACK information is later than or no earlier than the transmission of the second HARQ-ACK information. In some embodiments, the condition can comprise that the transmission of the first HARQ-ACK information is earlier than the transmission of the second HARQ-ACK information, and an ending symbol of the first PDCCH is later than an ending symbol of the second PDCCH. In some other embodiments, the condition can comprise that a starting symbol or an ending symbol of a resource for the transmission of the first HARQ-ACK information is earlier than a starting symbol or an ending symbol of a resource for the transmission of the second HARQ-ACK information, and an ending symbol of the first PDCCH is later than an ending symbol of the second PDCCH. In some embodiments, if the transmission of the first HARQ-ACK information is later than or no earlier than the transmission of the second HARQ-ACK information, and the ending symbol of the first PDCCH is earlier than or no later than the ending symbol of the second PDCCH, the terminal device 130 can determine to ignore or not to apply the first TCI state.

For example, in some embodiments, the second TCI state corresponding to codepoint in TCI field in the second PDCCH and the first TCI state corresponding to codepoint in TCI field in the first PDCCH can be applied to a same subset of M and/or N or in case of joint HARQ-ACK feedback. In case of out of order HARQ feedback, in a second HARQ-ACK feedback 332, TCI state(s) indicated in the PDCCH 322 which is no later than the PDCCH 311 may not be applied (for example, even different from current TCI state(s)) after beam application timing. The HARQ-ACK information corresponding to the PDCCH 322 may be included in the second HARQ-ACK feedback 332, and HARQ-ACK information corresponding to the PDCCH 311 may be included in the HARQ-ACK feedback 331. The PDCCH 311 is a PDCCH with indication of TCI state(s) which is applied or to be applied based on a first HARQ-ACK feedback 331. The first HARQ-ACK feedback 331 can be any one or a latest HARQ feedback which is earlier than the second HARQ feedback 332.

In some embodiment, if a CORESET is configured to not share or apply the indicated TCI state (i.e., the first TCI state), the TCI state for the PDCCH in the CORESET can be activated by a MAC CE. If M is larger than 1, the CORESET may still be included in one subset of M subsets of CORESETs. The TCI state for the PDSCH in the CORESET may follow PDCCH or indicated in the TCI field. For example, the network device 110 may transmit 2050 a MAC CE to the terminal device 130. The MA CE may comprise an activation of a third TCI state for a CORESET. The CORESET can be configured to not share or apply the unified TCI state. The network device 110 may also transmit 2060 a third PDCCH in the CORESET. The third PDCCH can schedule a third PDSCH. In this case, the terminal device 130 can apply at least one quasi co-location (QCL) parameters as the ones associated with the third TCI state for the third PDSCH or applying at least one QCL parameters as the ones associated with a fourth TCI state. The fourth TCI state can be indicated in a TCI field in the third PDCCH for the third PDSCH. In some embodiments, there may be no scheduling of PUSCH for the third PDCCH in the CORESET.

In some embodiments, the spatial relation information for PUSCH scheduled by the PDCCH may follow UL TCI or joint TCI applied to all or subset of PUCCHs corresponding to the subset of CORESET or indicated/applied by PDCCHs in the same subset of CORESET which shares/applies the indicated Rel-17 TCI state. For example, the terminal device 130 may apply a spatial domain filter as the one associated with an uplink TCI state to a subset of PUSCHs corresponding to a subset of CORESET. Alternatively, the terminal device 130 may apply a spatial domain filter as the one associated with a joint TCI state to the subset of PUSCHs corresponding to the subset of CORESET. In some other embodiments, the terminal device 130 may apply the spatial domain filter as the one associated with the uplink TCI state to all of PUSCHs corresponding to the subset of CORESET. In some embodiments, the terminal device 130 may apply the spatial domain filter as the one associated with the joint TCI state to all of PUSCHs corresponding to the subset of CORESET. Additionally, the terminal device 130 may apply the spatial domain filter as the one associated with the uplink TCI state or the joint TCI state to a subset of PUSCHs indicated by PDCCHs in the subset of CORESET which applies the first TCI state. In some embodiments, the terminal device 130 may apply the spatial domain filter as the one associated with the uplink TCI state or the joint TCI state to all of PUSCHs indicated by PDCCHs in the subset of CORESET which applies the first TCI state.

Alternatively, the spatial relation information for PUSCH scheduled by the PDCCH may follow TCI state for the PDCCH or PDSCH. For example, the terminal device 130 may apply a spatial domain filter as the one associated with the third TCI state to PUSCHs scheduled by the third PDCCH. Alternatively, the terminal device 130 may apply a spatial domain filter as the one associated with the fourth TCI state to PUSCHs scheduled by the third PDCCH.

In some other embodiments, the spatial relation information for PUSCH scheduled by the PDCCH may follow TCI state configured/activated for a PUCCH with lowest index among PUCCH_na (at least for PUSCH scheduled by DCI format 0_0). For example, the terminal device 130 may apply a spatial domain filter as the one associated with a fifth TCI state to PUSCHs scheduled by the third PDCCH. In this case, the fifth TCI state can be configured for a PUCCH with a lowest index among the PUCCHs and the PUCCHs can be configured to not share or apply the unified TCI state.

In some embodiments, the spatial relation information for PUCCH may follow UL TCI or joint TCI applied to all or subset of PUCCHs corresponding to the subset of CORESET. For example, the terminal device 130 may apply a spatial domain filter as the one associated with an uplink TCI state or the joint TCI state to a subset of PUCCHs corresponding to a subset of the CORESET. In other embodiments, the terminal device 130 may apply the spatial domain filter as the one associated with the uplink TCI state or the joint TCI state to all of PUCCHs corresponding to the subset of the CORESET.

Alternatively, the spatial relation information for PUCCH may follow TCI state for the PDCCH or PDSCH. For example, the terminal device 130 may apply the spatial domain filter as the one associated with the third TCI state to a PUCCH for a third HARQ-ACK information transmission corresponding to a third PDSCH scheduled by the third PDCCH. In other embodiments, the terminal device 130 may apply the spatial domain filter as the one associated with the fourth TCI state to the PUCCH for the third HARQ-ACK information transmission corresponding to the third PDSCH scheduled by the third PDCCH.

In some embodiments, the spatial relation information for PUCCH may follow TCI state configured/activated for PUCCH_na. For example, the terminal device 130 may apply a spatial domain filter as the one associated with a sixth TCI state to a PUCCH, wherein the sixth TCI state is configured for the PUCCH.

In some embodiments, in case of M>1, in a TCI field in a PDCCH in one subset of CORESETs, (e.g. for DL) each codepoint corresponds to only one DL TCI or joint TCI state, and the DL TCI or joint TCI can be applied to the subset of CORESETs after beam application timing. And/or each codepoint corresponds to none or only one UL TCI or joint TCI state (e.g. for UL), and the UL TCI or joint TCI is applied to one of N subsets of PUCCH and/or PUSCH scheduled by PDCCH in the subset of CORESETs. In some embodiments, there may be one to one mapping between M and N, i.e. a PDCCH in one subset of M subsets of CORESETs can indicate up to one UL or joint TCI state for one of N subsets of PUCCH and PUSCH scheduled by PDCCH in the subset of CORESETs. In case of M>N, a PDCCH in one of N subsets (e.g. the first N subsets, or with lowest N values of subset index) selected from the M subsets can indicate TCI state for one of N subsets of PUCCH and PUSCH scheduled by PDCCH in the subset of CORESETs respectively. For the other M-N subsets, in some embodiments, a PDCCH in one of the last M-N subsets of CORESETs doesn't indicate UL TCI state and/or joint TCI state (only update/indicate DL TCI for the M-N subsets of CORESETs and corresponding PDSCH). The PDCCH doesn't schedule PUSCH. Spatial relation of PUSCH scheduled by the PDCCH may follow one of N subsets. Alternatively, for the other M-N subsets, a PDCCH in one of the last M-N subsets of CORESETs can indicate UL TCI state for one of N subsets of PUCCH and PUSCH scheduled by PDCCH in the subset. If a set of activated TCI states corresponding to one subset is joint TCI states, it should be included in the N subsets from the M subsets.

In some embodiments, the maximum value between M and N can be 2. For example, if both M and N are 2, there may be one to one mapping between M and N. Alternatively, the M can be 2 (first subset of CORESETs, e.g. represented as M1, second subset of CORESETs, e.g. represented as M2) and the N can be 1. In this case, TCI state(s) indicated in a PDCCH in M1 can be applied to PDCCHs in M1 and corresponding PDSCH, and applied to all PUCCH and PUSCH scheduled by PDCCH in M1. TCI state(s) indicated in a PDCCH in M2 can be applied to PDCCHs in M2 and corresponding PDSCH. In some embodiments, each codepoint in TCI field in the PDCCH in M2 can only corresponds to DL only TCI state (no UL TCI state and no joint TCI state). In some embodiments, PDCCHs in M2 may not schedule PUSCH. In some embodiments, PUSCH scheduled by PDCCHs in M2 may follow the UL or joint TCI state indicated in the first PDCCH. Alternatively, PUCCH for HARQ-ACK feedback corresponding to PDSCH scheduled by PDCCHs in M2 may follow the UL or joint TCI state indicated in the PDCCH in M1. In other embodiments, at least one codepoint in TCI field in the second PDCCH can correspond to UL TCI state (e.g. no joint TCI state). For example, the indicated UL TCI state can be applied to PUCCH and PUSCH (can be scheduled by the first PDCCH and/or second PDCCH).

In some embodiments, for an indication of spatial filter (e.g. UL beam) for uplink transmission, up to N UL TCI states (or joint TCI states) can map to one TCI codepoint in a DCI in a PDCCH in one subset of CORESETs, and each TCI state correspond to one subset of PUCCHs. In some other embodiments, the configured/activated UL TCI states can be divided into N groups (e.g. each group includes non-overlapping/non-reduplicative TCI states with any one of other groups), a PDCCH in one subset of CORESETs can indicate any one of activated UL TCI states. For example, spatial filter for the PUSCH scheduled by the PDCCH and/or PUCCH for HARQ-ACK feedback corresponding to the PDSCH scheduled by the PDCCH or corresponding to the PDCCH may be based on the (current) applied UL TCI state for a subset of PUCCHs, wherein the subset is determined as a subset corresponding to the indicated UL TCI state (i.e. the subset is the one includes the indicated UL TCI states). In some embodiments, the DCI in the PDCCH may include an indication of index of subsets of PUCCHs. In other embodiments, one SRS resource set may include more than one SRS resource. In this case, each SRS resource corresponding to one subset of PUCCHs, in case of PUSCH scheduling, spatial filter for the PUSCH may be based on the (current) applied TCI state for a subset of PUCCH which corresponds to the indicated SRS resource.

In some embodiments, the M can be 1 and the N can be 2 (first subset of PUCCHs, e.g. N1, second subset of PUCCHs, e.g. N2). In this case, one SRS resource set may include more than one SRS resources, and each SRS resource corresponding to one subset of PUCCHs, in case of PUSCH scheduling, spatial filter for the PUSCH may be based on the (current) applied TCI state for a subset of PUCCH which corresponds to the indicated SRS resource. For example, if indicated SRS resource in a DCI for PUSCH scheduling corresponds to N1, spatial filter for the PUSCH may be based on the applied TCI state for N1. Alternatively, if indicated SRS resource in a DCI for PUSCH scheduling corresponds to N2, spatial filter for the PUSCH may be based on the applied TCI state for N2.

In some embodiments, in case of different configurations of DL and UL multi-TRP, the HARQ-ACK feedback modes may be different. For example, if a first number of subsets of CORESETs is not larger than a second number of subsets of physical uplink control channel (PUCCH) or physical uplink shared channel (PUSCH), a HARQ-ACK feedback mode is configured to be separate. For example, in case of M=N>1 (e.g. one to one mapping) and/or M<N (e.g. each subset of N corresponds to only one subset of M), the HARQ-ACK feedback mode may be assumed/expected to be separate or not configured.

Alternatively, if the first number of subsets of CORESETs is larger than the second number of subsets of PUCCH or PUSCH, a first group of subsets of CORESETs correspond to a first group of subsets of PUCCH or PUSCH, and a second group of subsets of CORESETs correspond to a second group of subsets of PUCCH or PUSCH, a first HARQ-ACK feedback mode within the first group of subsets of CORESETs or the second group of subsets of CORESETs is configured to be joint, and a second HARQ-ACK feedback mode between the first and second groups of subsets of CORESETs is configured to be separate.

In some embodiments, if the first number of subsets of CORESETs is larger than the second number of subsets of PUCCH or PUSCH, and the second number of subsets of PUCCH or PUSCH is one, a HARQ-ACK feedback mode is configured to be joint. For example, in case of M>N (e.g. each subset of CORESETs corresponds to only one subset of PUCCH) and/or at least one of M,N>1 (and at least one subset of CORESETs corresponds to a same subset of PUCCH), a first group of subsets of CORESETs (M_G1) corresponds to N1, and a second group of subsets of CORESETs (M_G2) corresponds to N2 within the first group M_G1 or within the second group M_G2, HARQ-ACK feedback mode may be assumed/expected to be joint, and between the first group and the second group, HARQ-ACK feedback mode may be assumed/expected to be separate.

In some other embodiments, if the first number of subsets of CORESETs is larger than the second number of subsets of PUCCH or PUSCH, the second number of subsets of PUCCH or PUSCH is one, and a HARQ-ACK feedback mode is configured to be separate. In this case, if there are two PUCCHs with HARQ-ACK information in one slot, the terminal device 130 may multiplex the HARQ-ACK information in one PUCCH. For example, in case of M>=2, N=1, the HARQ-ACK feedback mode may be assumed or expected to be joint. Alternatively, if HARQ-ACK feedback mode is configured as separate, and if there are two PUCCHs with HARQ-ACK information in one slot, the HARQ-ACK information may be multiplexed in one PUCCH and transmitted in later or earlier PUCCH resource or with lower ID. The two PUCCH resources can overlap in symbols.

In some embodiments, in case of separate HARQ-ACK feedback mode or one to one mapping between M and N (with M=N>1), in a PDCCH in one subset of M, the determined/indicated PUCCH resource index can be a relative index within one subset of N corresponding to the subset of CORESET. For example, PUCCH resource groups may be reused for the subsets of PUCCH. Alternatively, if PUCCH resource index is absolute value (or indexed across N subsets), in a PDCCH in one subset of M, the determined/indicated PUCCH resource index may be not expected to be a PUCCH included in a subset of PUCCH which not corresponding to the subset of CORESET.

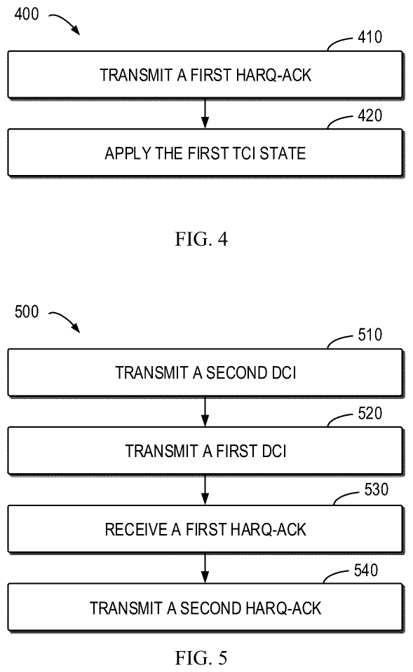

FIG. 4 shows a flowchart of an example method 400 in accordance with an embodiment of the present disclosure. The method 400 can be implemented at any suitable devices. Only for the purpose of illustrations, the method 400 can be implemented at a terminal device 130 as shown in FIG. 1.

At block 410, the terminal device 130 transmits first HARQ-ACK information to the network device 110. The first HARQ-ACK information corresponds to the first DCI in the first PDCCH. In some embodiments, the first HARQ-ACK information can be transmitted to the TRP 120-1.

In some embodiments, the terminal device 130 may transmit second HARQ-ACK information to the network device 110. The second HARQ-ACK information corresponds to the second DCI in the second PDCCH. In some embodiments, the second HARQ-ACK information can be transmitted to the TRP 120-2.

At block 420, if a condition is fulfilled, the terminal device 130 applies the first TCI state. In some embodiments, the terminal device 130 may apply the first TCI state to all PUCCHs. Alternatively, the terminal device 130 may apply the first TCI state to a subset of PUCCHs. For example, some PUCCHs (for example, presented as PUCCH_na) can be configured to apply or not apply the indicated TCI state. In some embodiments, not applying the first TCI state may be configured conditioned on when a CORESET is configured to not apply the indicated TCI state. The PUCCH not applying the indicated TCI state may be applied for HARQ-ACK feedback for PDSCH scheduled by the CORESET (not applying the indicated TCI state).

In some embodiments, the condition can comprise that at least one bit value of the HARQ-ACK information corresponding to the first DCI or corresponding to a PDSCH scheduled by the first DCI is ACK.

In some embodiments, the condition can comprise that the first TCI state is configured for TCI update in unified TCI framework. Alternatively or in addition, the condition can comprise that the first TCI state is a unified TCI state. In some embodiments, the condition can comprise that the first TCI state is configured with tci-StateId-r17. In some embodiments, the condition may comprise that the first TCI state is labelled with a parameter, wherein the parameter is tci-StateId-r17 or r17. In some other embodiments, the condition can comprise that the first TCI state is different from a seventh TCI state. The seventh TCI state can be at least one of: a previous applied unified TCI state, a previous indicated unified TCI state, or a current applied unified TCI state.

In some embodiments, the condition can comprise that the first DCI is not a DCI scheduling semi-persistent scheduling (SPS) activation. Alternatively or in addition, the condition may comprise that the first DCI is not a DCI scheduling SPS release. In some other embodiments, the condition can comprise that the first DCI is a DCI carrying a unified TCI state or a TCI state for TCI state update or a TCI state configured with tci-StateId-r17. In some embodiments, the condition can comprise that the first PDCCH is not a PDCCH in a control resource set (CORESET) which is not configured to share or apply the unified TCI state. Alternatively or in addition, the condition can comprise that the first PDCCH is a PDCCH in a CORESET which is configured to share or apply the unified TCI state.

In some embodiments, the HARQ-ACK information may comprise more than one HARQ-ACK information bit. Alternatively or in addition, the PDSCH may comprise two transport blocks. In this case, each transport block can correspond to one HARQ-ACK information bit. In some other embodiments, the PDSCH may comprise one transport block. In some embodiments, the least one transport block in the PDSCH may comprise more than one code block groups (CBGs). In this case, each CBG can correspond to one HARQ-ACK information bit.

In some embodiments, as mentioned above, the terminal device 130 can receive the first PDCCH and the second PDCCH. In this case, the condition can comprise that the transmission of the first HARQ-ACK information is later than or no earlier than the transmission of the second HARQ-ACK information. In some embodiments, the condition can comprise that the transmission of the first HARQ-ACK information is earlier than the transmission of the second HARQ-ACK information, and an ending symbol of the first PDCCH is later than an ending symbol of the second PDCCH. In some other embodiments, the condition can comprise that a starting symbol or an ending symbol of a resource for the transmission of the first HARQ-ACK information is earlier than a starting symbol or an ending symbol of a resource for the transmission of the second HARQ-ACK information, and an ending symbol of the first PDCCH is later than an ending symbol of the second PDCCH. In some embodiments, if the transmission of the first HARQ-ACK information is later than or no earlier than the transmission of the second HARQ-ACK information, and the ending symbol of the first PDCCH is earlier than or no later than the ending symbol of the second PDCCH, the terminal device 130 can determine to ignore or not to apply the first TCI state.

In some embodiments, the terminal device 130 may receive or detect a first DCI in a first PDCCH in a first subset of CORESETs (e.g. M1), and the first DCI may indicate a first TCI state. In some embodiments, the terminal device 130 may receive or detect a second DCI in a second PDCCH in a second subset of CORESETs (e.g. M2), and the second DCI may indicate a second TCI state. For example, the first TCI state and the second TCI state may be different. For another example, at least one of the downlink TCI state, uplink TCI state and joint TCI state of the first TCI state may be different from at least one of the downlink TCI state, uplink TCI state and joint TCI state of the second TCI state. In some embodiments, the terminal device 130 may transmit first HARQ-ACK information for the first DCI or for the PDSCH scheduled by the first DCI. For example, the first HARQ-ACK information may be transmitted in a first uplink resource. For example, the first uplink resource may be a first PUCCH resource or a first PUSCH resource. In some embodiments, the terminal device 130 may transmit second HARQ-ACK information for the second DCI or for the PDSCH scheduled by the second DCI. For example, the second HARQ-ACK information may be transmitted in a second uplink resource. For example, the second uplink resource may be a second PUCCH resource or a second PUSCH resource. In some embodiments, the first uplink resource may be different from the second uplink resource.

In some embodiments, the first TCI state may be applied after a first application timing, wherein the first application timing may be the first slot or first subslot which is Y symbols after the last symbol of the first uplink resource. In some embodiments, the second TCI state may be applied after a second application timing, wherein the second application timing may be the first slot or first subslot which is Y symbols after the last symbol of the second uplink resource.

In some embodiments, the first PDCCH may be earlier than or no later than the second PDCCH. For example, at least one of the starting symbol, the first symbol, the ending symbol and the last symbol of the first PDCCH may be earlier than or no later than at least one of the starting symbol, the first symbol, the ending symbol and the last symbol of the second PDCCH. In some embodiments, the first uplink resource may be later than or no earlier than the second uplink resource. For example, at least one of the slot, the starting symbol, the first symbol, the ending symbol and the last symbol of the first uplink resource may be later than or no earlier than at least one of the slot, the starting symbol, the first symbol, the ending symbol and the last symbol of the second uplink resource. In some embodiments, the first application timing may be later than or no earlier than the second application timing. In some embodiments, the first TCI state may not be applied or may be ignored after the first application timing. In some embodiments, at least one of the HARQ-ACK information bit in the first HARQ-ACK information may be ACK. In some embodiments, at least one of the HARQ-ACK information bit in the second HARQ-ACK information may be ACK. In some embodiments, the first HARQ-ACK information may be in a first HARQ-ACK codebook in the first uplink resource. In some embodiments, the second HARQ-ACK information may be in a second HARQ-ACK codebook in the second uplink resource.

In some embodiments, in a first HARQ-ACK codebook in the first uplink resource, TCI state(s) indicated in a first PDCCH (if any) which is no later than or earlier than a second PDCCH will not be applied (e.g. even different from current TCI state(s)) after beam application timing, wherein HARQ-ACK information corresponding to the first PDCCH is included in the first HARQ-ACK codebook, and HARQ-ACK information corresponding to the second PDCCH is included in the second HARQ-ACK codebook. And the second PDCCH is a PDCCH with indication of TCI state(s) which is applied or to be applied based on a second HARQ-ACK codebook in the second uplink resource, wherein the second HARQ-ACK codebook is any one or a latest HARQ-ACK codebook (for example, in a latest uplink resource) which is earlier than the first HARQ-ACK codebook in the first uplink resource.

In some embodiments, to determine TCI state(s) to be applied after the application timing, only TCI state(s) indicated in a PDCCH which is later than or no earlier than a PDCCH which indicates a TCI state which is applied are considered.

In some embodiment, if a CORESET is configured to not share or apply the indicated TCI state (i.e., the first TCI state), the TCI state for the PDCCH in the CORESET can be activated by a MAC CE. If M is larger than 1, the CORESET may still be included in one subset of M subsets of CORESETs. The TCI state for the PDSCH in the CORESET may follow PDCCH or indicated in the TCI field.

In some embodiments, the spatial relation information for PUSCH scheduled by the PDCCH may follow UL TCI or joint TCI applied to all or subset of PUCCHs corresponding to the subset of CORESET or indicated/applied by PDCCHs in the same subset of CORESET which shares/applies the indicated Rel-17 TCI state. For example, the terminal device 130 may apply a spatial domain filter as the one associated with an uplink TCI state to a subset of PUSCHs corresponding to a subset of CORESET. Alternatively, the terminal device 130 may apply a spatial domain filter as the one associated with a joint TCI state to the subset of PUSCHs corresponding to the subset of CORESET. In some other embodiments, the terminal device 130 may apply the spatial domain filter as the one associated with the uplink TCI state to all of PUSCHs corresponding to the subset of CORESET. In some embodiments, the terminal device 130 may apply the spatial domain filter as the one associated with the joint TCI state to all of PUSCHs corresponding to the subset of CORESET. Additionally, the terminal device 130 may apply the spatial domain filter as the one associated with the uplink TCI state or the joint TCI state to a subset of PUSCHs indicated by PDCCHs in the subset of CORESET which applies the first TCI state. In some embodiments, the terminal device 130 may apply the spatial domain filter as the one associated with the uplink TCI state or the joint TCI state to all of PUSCHs indicated by PDCCHs in the subset of CORESET which applies the first TCI state.

Alternatively, the spatial relation information for PUSCH scheduled by the PDCCH may follow TCI state for the PDCCH or PDSCH. For example, the terminal device 130 may apply a spatial domain filter as the one associated with the third TCI state to PUSCHs scheduled by the third PDCCH. Alternatively, the terminal device 130 may apply a spatial domain filter as the one associated with the fourth TCI state to PUSCHs scheduled by the third PDCCH.

In some other embodiments, the spatial relation information for PUSCH scheduled by the PDCCH may follow TCI state configured/activated for a PUCCH with lowest index among PUCCH_na (at least for PUSCH scheduled by DCI format 0_0). For example, the terminal device 130 may apply a spatial domain filter as the one associated with a fifth TCI state to PUSCHs scheduled by the third PDCCH. In this case, the fifth TCI state can be configured for a PUCCH with a lowest index among the PUCCHs and the PUCCHs can be configured to not share or apply the unified TCI state.

In some embodiments, the spatial relation information for PUCCH may follow UL TCI or joint TCI applied to all or subset of PUCCHs corresponding to the subset of CORESET. For example, the terminal device 130 may apply a spatial domain filter as the one associated with an uplink TCI state or the joint TCI state to a subset of PUCCHs corresponding to a subset of the CORESET. In other embodiments, the terminal device 130 may apply the spatial domain filter as the one associated with the uplink TCI state or the joint TCI state to all of PUCCHs corresponding to the subset of the CORESET.

Alternatively, the spatial relation information for PUCCH may follow TCI state for the PDCCH or PDSCH. For example, the terminal device 130 may apply the spatial domain filter as the one associated with the third TCI state to a PUCCH for a third HARQ-ACK information transmission corresponding to a third PDSCH scheduled by the third PDCCH. In other embodiments, the terminal device 130 may apply the spatial domain filter as the one associated with the fourth TCI state to the PUCCH for the third HARQ-ACK information transmission corresponding to the third PDSCH scheduled by the third PDCCH.

In some embodiments, the spatial relation information for PUCCH may follow TCI state configured/activated for PUCCH_na. For example, the terminal device 130 may apply a spatial domain filter as the one associated with a sixth TCI state to a PUCCH, wherein the sixth TCI state is configured for the PUCCH.

In some other embodiments, if the first number of subsets of CORESETs is larger than the second number of subsets of PUCCH or PUSCH, the second number of subsets of PUCCH or PUSCH is one, and a HARQ-ACK feedback mode is configured to be separate. In this case, if there are two PUCCHs with HARQ-ACK information in one slot, the terminal device 130 may multiplex the HARQ-ACK information in one PUCCH. For example, in case of M>=2, N=1, the HARQ-ACK feedback mode may be assumed or expected to be joint. Alternatively, if HARQ-ACK feedback mode is configured as separate, and if there are two PUCCHs with HARQ-ACK information in one slot, the HARQ-ACK information may be multiplexed in one PUCCH and transmitted in later or earlier PUCCH resource or with lower ID. The two PUCCH resources can overlap in symbols.

In some embodiments, in case of separate HARQ-ACK feedback mode or one to one mapping between M and N (with M=N>1), in a PDCCH in one subset of M, the determined/indicated PUCCH resource index can be a relative index within one subset of N corresponding to the subset of CORESET. For example, PUCCH resource groups may be reused for the subsets of PUCCH. Alternatively, if PUCCH resource index is absolute value (or indexed across N subsets), in a PDCCH in one subset of M, the determined/indicated PUCCH resource index may be not expected to be a PUCCH included in a subset of PUCCH which not corresponding to the subset of CORESET.

FIG. 5 shows a flowchart of an example method 500 in accordance with an embodiment of the present disclosure. The method 500 can be implemented at any suitable devices. Only for the purpose of illustrations, the method 500 can be implemented at a network device 110 as shown in FIG. 1.

At block 510, the network device 110 transmits a second PDCCH to the terminal device 130. The second PDCCH comprises second DCI. The second DCI indicates a second TCI state. In some embodiments, the second PDCCH can be received from the TRP 120-2.

At block 520, the network device 110 transmits a first PDCCH to the terminal device 130. The first PDCCH comprises first DCI. The first DCI indicates a first TCI state. In some embodiments, the first PDCCH can be received from the TRP 120-1.

At block 530, the network device 110 receives first HARQ-ACK information from the terminal device 130. The first HARQ-ACK information corresponds to the first DCI in the first PDCCH. In some embodiments, the first HARQ-ACK information can be transmitted to the TRP 120-1.

At block 540, the network device 110 receives second HARQ-ACK information from the terminal device 130. The second HARQ-ACK information corresponds to the second DCI in the second PDCCH. In some embodiments, the second HARQ-ACK information can be transmitted to the TRP 120-2.

In some embodiments, a terminal device comprise a circuitry configured to transmit, at a terminal device and to a network device, a first hybrid automatic repeat request acknowledgement (HARQ-ACK) information corresponding to a first downlink control information (DCI) in a first physical downlink control channel (PDCCH), wherein the first DCI indicates a first transmission configuration indicator (TCI) state; and in accordance with a condition is fulfilled, apply the first TCI state.

In some embodiments, the condition comprises at least one of: at least one bit value of the HARQ-ACK information corresponding to the first DCI or corresponding to a physical downlink shared channel (PDSCH) scheduled by the first DCI is acknowledgement (ACK); the first TCI state is configured for TCI update in unified TCI framework; the first TCI state is a unified TCI state; the first TCI state is configured with tci-StateId-r17; the first TCI state is labelled with a parameter, wherein the parameter is tci-StateId-r17 or r17; the first TCI state is different from a seventh TCI state, wherein the seventh TCI state is at least one of: a previous applied unified TCI state, a previous indicated unified TCI state, or a current applied unified TCI state; the first DCI is not a DCI scheduling semi-persistent scheduling (SPS) activation; the first DCI is not a DCI scheduling SPS release; the first DCI is a DCI carrying a unified TCI state or a TCI state for TCI state update or a TCI state configured with tci-StateId-r17; the first PDCCH is not a PDCCH in a control resource set (CORESET) which is not configured to share or apply the unified TCI state; or the first PDCCH is a PDCCH in a CORESET which is configured to share or apply the unified TCI state.

In some embodiments, the HARQ-ACK information comprises more than one HARQ-ACK information bit.

In some embodiments, the PDSCH comprises two transport blocks, wherein each transport block corresponds to one HARQ-ACK information bit.

In some embodiments, the PDSCH comprises one transport block.

In some embodiments, at least one transport block in the PDSCH comprises more than one code block groups (CBGs), wherein each CBG corresponds to one HARQ-ACK information bit.

In some embodiments, the terminal device comprises the circuitry configured to transmit, at the terminal device and to the network device, a second HARQ-ACK information corresponding to a second DCI in a second PDCCH, wherein the second DCI indicates a second TCI state.

In some embodiments, the condition comprises at least one of: the transmission of the first HARQ-ACK information is later than or no earlier than the transmission of the second HARQ-ACK information; the transmission of the first HARQ-ACK information is earlier than the transmission of the second HARQ-ACK information, and an ending symbol of the first PDCCH is later than an ending symbol of the second PDCCH; or a starting symbol or an ending symbol of a resource for the transmission of the first HARQ-ACK information is earlier than a starting symbol or an ending symbol of a resource for the transmission of the second HARQ-ACK information, and an ending symbol of the first PDCCH is later than an ending symbol of the second PDCCH.

In some embodiments, the terminal device comprises the circuitry configured to determine to ignore or not to apply the first TCI state, if the transmission of the first HARQ-ACK information is later than or no earlier than the transmission of the second HARQ-ACK information, and the ending symbol of the first PDCCH is earlier than or no later than the ending symbol of the second PDCCH.

In some embodiments, if a first number of subsets of CORESETs is not larger than a second number of subsets of physical uplink control channel (PUCCH) or physical uplink shared channel (PUSCH), a HARQ-ACK feedback mode is configured to be separate.

In some embodiments, if the first number of subsets of CORESETs is larger than the second number of subsets of PUCCH or PUSCH, a first group of subsets of CORESETs correspond to a first group of subsets of PUCCH or PUSCH, and a second group of subsets of CORESETs correspond to a second group of subsets of PUCCH or PUSCH, a first HARQ-ACK feedback mode within the first group of subsets of CORESETs or the second group of subsets of CORESETs is configured to be joint; and a second HARQ-ACK feedback mode between the first and second groups of subsets of CORESETs is configured to be separate.

In some embodiments, if the first number of subsets of CORESETs is larger than the second number of subsets of PUCCH or PUSCH, and the second number of subsets of PUCCH or PUSCH is one, a HARQ-ACK feedback mode is configured to be joint.

In some embodiments, if the first number of subsets of CORESETs is larger than the second number of subsets of PUCCH or PUSCH, the second number of subsets of PUCCH or PUSCH is one, and a HARQ-ACK feedback mode is configured to be separate. The terminal device comprises the circuitry configured to in accordance with a determination that there are two PUCCHs with HARQ-ACK information in one slot, multiplex the HARQ-ACK information in one PUCCH.

In some embodiments, the terminal device comprises the circuitry configured to apply the first TCI state to all PUCCHs; or apply the first TCI state to a subset of PUCCHs.

In some embodiments, the terminal device comprises the circuitry configured to receive an activation of a third TCI state for a CORESET in a medium access control control element (MAC CE), wherein the CORESET is configured to not share or apply the unified TCI state; receive a third PDCCH in the CORESET, wherein the third PDCCH schedules a third PDSCH; and apply at least one quasi co-location (QCL) parameters as the ones associated with the third TCI state for the third PDSCH or applying at least one QCL parameters as the ones associated with a fourth TCI state, wherein the fourth TCI state is indicated in a TCI field in the third PDCCH for the third PDSCH.

In some embodiments, there is no scheduling of PUSCH for the third PDCCH in the CORESET.

In some embodiments, the terminal device comprises the circuitry configured to apply a spatial domain filter as the one associated with an uplink TCI state to a subset of PUSCHs corresponding to a subset of CORESET; apply a spatial domain filter as the one associated with a joint TCI state to the subset of PUSCHs corresponding to the subset of CORESET; apply the spatial domain filter as the one associated with the uplink TCI state to all of PUSCHs corresponding to the subset of CORESET; apply the spatial domain filter as the one associated with the joint TCI state to all of PUSCHs corresponding to the subset of CORESET; apply the spatial domain filter as the one associated with the uplink TCI state or the joint TCI state to a subset of PUSCHs indicated by PDCCHs in the subset of CORESET which applies the first TCI state; or apply the spatial domain filter as the one associated with the uplink TCI state or the joint TCI state to all of PUSCHs indicated by PDCCHs in the subset of CORESET which applies the first TCI state.

In some embodiments, the terminal device comprises the circuitry configured to apply a spatial domain filter as the one associated with the third TCI state to PUSCHs scheduled by the third PDCCH; or apply a spatial domain filter as the one associated with the fourth TCI state to PUSCHs scheduled by the third PDCCH.

In some embodiments, the terminal device comprises the circuitry configured to apply a spatial domain filter as the one associated with a fifth TCI state to PUSCHs scheduled by the third PDCCH, wherein the fifth TCI state is configured for a PUCCH with a lowest index among the PUCCHs, wherein the PUCCHs are configured to not share or apply the unified TCI state.

In some embodiments, the terminal device comprises the circuitry configured to apply a spatial domain filter as the one associated with an uplink TCI state or the joint TCI state to a subset of PUCCHs corresponding to a subset of the CORESET; or apply the spatial domain filter as the one associated with the uplink TCI state or the joint TCI state to all of PUCCHs corresponding to the subset of the CORESET.

In some embodiments, the terminal device comprises the circuitry configured to apply the spatial domain filter as the one associated with the third TCI state to a PUCCH for a third HARQ-ACK information transmission corresponding to a third PDSCH scheduled by the third PDCCH; or apply the spatial domain filter as the one associated with the fourth TCI state to the PUCCH for the third HARQ-ACK information transmission corresponding to the third PDSCH scheduled by the third PDCCH.

In some embodiments, the terminal device comprises the circuitry configured to apply a spatial domain filter as the one associated with a sixth TCI state to a PUCCH, wherein the sixth TCI state is configured for the PUCCH.

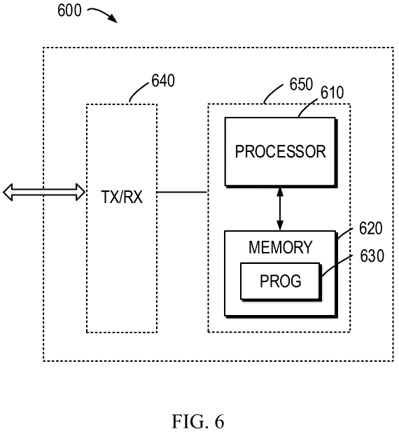

FIG. 6 is a simplified block diagram of a device 600 that is suitable for implementing embodiments of the present disclosure. The device 600 can be considered as a further example implementation of the network device 110 or the terminal device 130 as shown in FIG. 1. Accordingly, the device 600 can be implemented at or as at least a part of the network device 110 or the terminal device 130 as shown in FIG. 1.

As shown, the device 600 includes a processor 610, a memory 620 coupled to the processor 610, a suitable transmitter (TX) and receiver (RX) 640 coupled to the processor 610, and a communication interface coupled to the TX/RX 640. The memory 610 stores at least a part of a program 630. The TX/RX 640 is for bidirectional communications. The TX/RX 640 has at least one antenna to facilitate communication, though in practice an Access Node mentioned in this application may have several ones. The communication interface may represent any interface that is necessary for communication with other network elements, such as X2 interface for bidirectional communications between eNBs, S1 interface for communication between a Mobility Management Entity (MME)/Serving Gateway (S-GW) and the eNB, Un interface for communication between the eNB and a relay node (RN), or Uu interface for communication between the eNB and a terminal device.

The program 630 is assumed to include program instructions that, when executed by the associated processor 610, enable the device 600 to operate in accordance with the embodiments of the present disclosure, as discussed herein with reference to FIGS. 1 to 5. The embodiments herein may be implemented by computer software executable by the processor 610 of the device 600, or by hardware, or by a combination of software and hardware. The processor 610 may be configured to implement various embodiments of the present disclosure. Furthermore, a combination of the processor 610 and memory 620 may form processing means 650 adapted to implement various embodiments of the present disclosure.

The memory 620 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory, as non-limiting examples. While only one memory 620 is shown in the device 600, there may be several physically distinct memory modules in the device 600. The processor 610 may be of any type suitable to the local technical network, and may include one or more of general purpose computers, special purpose computers, microprocessors, digital signal processors (DSPs) and processors based on multicore processor architecture, as non-limiting examples. The device 600 may have multiple processors, such as an application specific integrated circuit chip that is slaved in time to a clock which synchronizes the main processor.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIGS. 1 to 5. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

As used herein, the term ‘terminal device’ refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (Iota) devices, Ultra-reliable and Low Latency Communications (URLLC) devices, Internet of Everything (Iowa) devices, machine type communication (MTC) devices, device on vehicle for V2X communication where X means pedestrian, vehicle, or infrastructure/network, devices for Integrated Access and Backhaul (IAB), Space borne vehicles or Air borne vehicles in Non-terrestrial networks (NTN) including Satellites and High Altitude Platforms (HAPs) encompassing Unmanned Aircraft Systems (UAS), eXtended Reality (XR) devices including different types of realities such as Augmented Reality (AR), Mixed Reality (MR) and Virtual Reality (VR), the unmanned aerial vehicle (UAV) commonly known as a drone which is an aircraft without any human pilot, devices on high speed train (HST), or image capture devices such as digital cameras, sensors, gaming devices, music storage and playback appliances, or Internet appliances enabling wireless or wired Internet access and browsing and the like. The ‘terminal device’ can further has ‘multicast/broadcast’ feature, to support public safety and mission critical, V2X applications, transparent IPv4/IPv6 multicast delivery, IPTV, smart TV, radio services, software delivery over wireless, group communications and Iota applications. It may also incorporated one or multiple Subscriber Identity Module (SIM) as known as Multi-SIM. The term “terminal device” can be used interchangeably with a UE, a mobile station, a subscriber station, a mobile terminal, a user terminal or a wireless device.

The term “network device” refers to a device which is capable of providing or hosting a cell or coverage where terminal devices can communicate. Examples of a network device include, but not limited to, a Node B (Node or NB), an evolved Node (anode or eNB), a next generation Node (gNB), a transmission reception point (TRP), a remote radio unit (RRU), a radio head (RH), a remote radio head (RRH), an IAB node, a low power node such as a femto node, a pico node, a reconfigurable intelligent surface (RIS), and the like.

The terminal device or the network device may have Artificial intelligence (AI) or Machine learning capability. It generally includes a model which has been trained from numerous collected data for a specific function, and can be used to predict some information.

The terminal or the network device may work on several frequency ranges, e.g. FR1 (410 MHz-7125 MHz), FR2 (24.25 GHz to 71 GHz), frequency band larger than 100 GHz as well as Tera Hertz(THz). It can further work on licensed/unlicensed/shared spectrum. The terminal device may have more than one connections with the network devices under Multi-Radio Dual Connectivity (MR-DC) application scenario. The terminal device or the network device can work on full duplex, flexible duplex and cross division duplex modes.

The embodiments of the present disclosure may be performed in test equipment, e.g. signal generator, signal analyzer, spectrum analyzer, network analyzer, test terminal device, test network device, channel emulator.

The embodiments of the present disclosure may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, 5.5G, 5G-Advanced networks, or the sixth generation (6G) networks.

1.-24. (canceled)

25. A method of communication performed by a terminal device, comprising:
receiving, from a network device, a first downlink control information (DCI) in a first set of control resource sets (CORESETs), and a second DCI in a second set of CORESETs, wherein the first DCI indicates a first transmission configuration indication (TCI) state and the second DCI indicates a second TCI state;
transmitting, to the network device, a first positive hybrid automatic repeat request acknowledgement (HARQ-ACK) corresponding to the first DCI or corresponding to a physical downlink shared channel (PDSCH) scheduled by the first DCI, and a second positive HARQ-ACK corresponding to the second DCI or corresponding to a PDSCH scheduled by the second DCI; and
transmitting, to the network device, at least one of a physical uplink shared channel (PUSCH) associated with the first set of CORESETs using a spatial domain filter corresponding to the first TCI state, and a PUSCH associated with the second set of CORESTs using a spatial domain filter corresponding to the second TCI state.

26. The method of claim 25, further comprising:
applying at least one of the first TCI state to physical downlink control channel (PDCCH) receptions in the first set of CORESETs and PDSCH receptions scheduled by the PDCCH receptions in the first set of CORESETs, and the second TCI state to PDCCH receptions in the second set of CORESETs and PDSCH receptions scheduled by the PDCCH receptions in the second set of CORESETs.

27. The method of claim 25, further comprising:
transmitting, to the network device, a physical uplink control channel (PUCCH) using a spatial domain filter corresponding to the first TCI state or the second TCI state based on a configuration.

28. The method of claim 25, wherein the first TCI state is applied from a first slot which is Y symbols after the last symbol of a PUCCH or a PUSCH with the first positive HARQ-ACK, Y is an integer, and the second TCI stat is applied from a first slot which is Y symbols after the last symbol of a PUCCH or a PUSCH with the second positive HARQ-ACK.

29. The method of claim 25, wherein the first TCI state is different from a TCI state previously indicated in the first set of CORESETs, and the second TCI state is different from a TCI state previously indicated in the second set of CORESETs.

30. The method of claim 25, wherein the first positive HARQ-ACK comprises at least one bit value corresponding to acknowledgement (ACK), and the second positive HARQ-ACK comprises at least one bit value corresponding to ACK.

31. A method of communication performed by a network device, comprising:
transmitting, to a terminal device, a first downlink control information (DCI) in a first set of control resource sets (CORESETs), and a second DCI in a second set of CORESETs, wherein the first DCI indicates a first transmission configuration indication (TCI) state and the second DCI indicates a second TCI state;
receiving, from the terminal device, a first positive hybrid automatic repeat request acknowledgement (HARQ-ACK) corresponding to the first DCI or corresponding to a physical downlink shared channel (PDSCH) scheduled by the first DCI, and a second positive HARQ-ACK corresponding to the second DCI or corresponding to a PDSCH scheduled by the second DCI; and
receiving, from the terminal device, at least one of a physical uplink shared channel (PUSCH) associated with the first set of CORESETs and a PUSCH associated with the second set of CORESTs, wherein the PUSCH associated with the first set of CORESETs is transmitted based on a spatial domain filter corresponding to the first TCI state, the PUSCH associated with the second set of CORESETs is transmitted based on a spatial domain filter corresponding to the second TCI state.

32. The method of claim 31, wherein the TCI state is applied to physical downlink control channel (PDCCH) receptions in the first set of CORESETs and PDSCH receptions scheduled by the PDCCH receptions in the first set of CORESETs, and the second TCI state is applied to PDCCH receptions in the second set of CORESETs and PDSCH receptions scheduled by the PDCCH receptions in the second set of CORESETs.

33. The method of claim 31, further comprising:
receiving, from the terminal device, a physical uplink control channel (PUCCH), wherein the PUCCH is transmitted based on a spatial domain filter corresponding to the first TCI state or the second TCI state selected based on a configuration.

34. The method of claim 31, wherein the first TCI state is applied from a first slot which is Y symbols after the last symbol of a PUCCH or a PUSCH with the first positive HARQ-ACK, Y is an integer, and the second TCI stat is applied from a first slot which is Y symbols after the last symbol of a PUCCH or a PUSCH with the second positive HARQ-ACK.

35. The method of claim 31, wherein the first TCI state is different from a TCI state previously indicated in the first set of CORESETs, and the second TCI state is different from a TCI state previously indicated in the second set of CORESETs.

36. The method of claim 31, wherein the first positive HARQ-ACK comprises at least one bit value corresponding to acknowledgement (ACK), and the second positive HARQ-ACK comprises at least one bit value corresponding to ACK.

37. A terminal device, comprising:
a processor configured to cause the terminal device to:
receive, from a network device, a first downlink control information (DCI) in a first set of control resource sets (CORESETs), and a second DCI in a second set of CORESETs, wherein the first DCI indicates a first transmission configuration indication (TCI) state and the second DCI indicates a second TCI state;
transmit, to the network device, a first positive hybrid automatic repeat request acknowledgement (HARQ-ACK) corresponding to the first DCI or corresponding to a physical downlink shared channel (PDSCH) scheduled by the first DCI, and a second positive HARQ-ACK corresponding to the second DCI or corresponding to a PDSCH scheduled by the second DCI; and
transmit, to the network device, at least one of a physical uplink shared channel (PUSCH) associated with the first set of CORESETs using a spatial domain filter corresponding to the first TCI state, and a PUSCH associated with the second set of CORESTs using a spatial domain filter corresponding to the second TCI state.

38. The terminal device of claim 37, the processor is further configured to cause the terminal device to:
apply at least one of the first TCI state to physical downlink control channel (PDCCH) receptions in the first set of CORESETs and PDSCH receptions scheduled by the PDCCH receptions in the first set of CORESETs, and the second TCI state to PDCCH receptions in the second set of CORESETs and PDSCH receptions scheduled by the PDCCH receptions in the second set of CORESETs.

39. The terminal device of claim 37, the processor is further configured to cause the terminal device to:
transmit, to the network device, a physical uplink control channel (PUCCH) using a spatial domain filter corresponding to the first TCI state or the second TCI state based on a configuration.

40. The terminal device of claim 37, wherein the first TCI state is applied from a first slot which is Y symbols after the last symbol of a PUCCH or a PUSCH with the first positive HARQ-ACK, Y is an integer, and the second TCI stat is applied from a first slot which is Y symbols after the last symbol of a PUCCH or a PUSCH with the second positive HARQ-ACK.

41. The terminal device of claim 37, wherein the first TCI state is different from a TCI state previously indicated in the first set of CORESETs, and the second TCI state is different from a TCI state previously indicated in the second set of CORESETs.

42. The terminal device of claim 37, wherein the first positive HARQ-ACK comprises at least one bit value corresponding to acknowledgement (ACK), and the second positive HARQ-ACK comprises at least one bit value corresponding to ACK.

43. A network device, comprising:
a processor configured to cause the network device to:
transmit, to a terminal device, a first downlink control information (DCI) in a first set of control resource sets (CORESETs), and a second DCI in a second set of CORESETs, wherein the first DCI indicates a first transmission configuration indication (TCI) state and the second DCI indicates a second TCI state;
receive, from the terminal device, a first positive hybrid automatic repeat request acknowledgement (HARQ-ACK) corresponding to the first DCI or corresponding to a physical downlink shared channel (PDSCH) scheduled by the first DCI, and a second positive HARQ-ACK corresponding to the second DCI or corresponding to a PDSCH scheduled by the second DCI; and
receive, from the terminal device, at least one of a physical uplink shared channel (PUSCH) associated with the first set of CORESETs and a PUSCH associated with the second set of CORESTs, wherein the PUSCH associated with the first set of CORESETs is transmitted based on a spatial domain filter corresponding to the first TCI state, the PUSCH associated with the second set of CORESETs is transmitted based on a spatial domain filter corresponding to the second TCI state.

44. The network device of claim 43, wherein the TCI state is applied to physical downlink control channel (PDCCH) receptions in the first set of CORESETs and PDSCH receptions scheduled by the PDCCH receptions in the first set of CORESETs, and the second TCI state is applied to PDCCH receptions in the second set of CORESETs and PDSCH receptions scheduled by the PDCCH receptions in the second set of CORESETs.

45. The network device of claim 43, the processor is further configured to cause the network device to:
receive, from the terminal device, a physical uplink control channel (PUCCH), wherein the PUCCH is transmitted based on a spatial domain filter corresponding to the first TCI state or the second TCI state selected based on a configuration.

46. The network device of claim 43, wherein the first TCI state is applied from a first slot which is Y symbols after the last symbol of a PUCCH or a PUSCH with the first positive HARQ-ACK, Y is an integer, and the second TCI stat is applied from a first slot which is Y symbols after the last symbol of a PUCCH or a PUSCH with the second positive HARQ-ACK.

47. The network device of claim 43, wherein the first TCI state is different from a TCI state previously indicated in the first set of CORESETs, and the second TCI state is different from a TCI state previously indicated in the second set of CORESETs.

48. The network device of claim 43, wherein the first positive HARQ-ACK comprises at least one bit value corresponding to acknowledgement (ACK), and the second positive HARQ-ACK comprises at least one bit value corresponding to ACK.
